(19) United States
(12) Patent Application Publication
(10) Pub. No.: US 2023/0353303 A1
(43) Pub. Date: Nov. 2, 2023

(54) METHOD AND APPARATUS FOR SRS CONFIGURATION

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 18/185,340

(22) Filed: Mar. 16, 2023

Related U.S. Application Data
(60) Provisional application No. 63/324,947, filed on Mar. 29, 2022.

(51) Int. Cl. H04W 72/21; H04L 5/00

(52) U.S. Cl. CPC H04L 5/0048; H04W 72/21

(57) ABSTRACT

Apparatuses and methods for SRS configuration are provided. A method performed by a user equipment (UE) includes receiving information about at least one sounding reference signal (SRS) related information (SRS-Info) that is associated with two groups of antenna ports; receiving an indication indicating X groups of the two groups of antenna ports; based on the indication, identifying the X groups of antenna ports; and transmitting an uplink (UL) transmission based on the X groups of antenna ports. When X = 1, the UL transmission corresponds to one physical uplink shared channel (PUSCH) transmission from one of the two groups of antenna ports. When X = 2, the UL transmission corresponds to one or two PUSCH transmissions from the two groups of antenna ports.

### CROSS-REFERENCE TO RELATED APPLICATION AND CLAIM OF PRIORITY

This application claims priority under 35 U.S.C. § 119(e) to U.S. Provisional Patent Application No. 63/324,947 filed on Mar. 29, 2022. The above-identified provisional patent application is hereby incorporated by reference in its entirety.

### TECHNICAL FIELD

The present disclosure relates generally to wireless communication systems and, more specifically, to sounding reference signal (SRS) configuration.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for SRS configuration.

In one embodiment, a user equipment (UE) is provided. The UE includes a transceiver configured to receive information about at least one SRS related information (SRS-Info) that is associated with two groups of antenna ports and receive an indication indicating X groups of the two groups of antenna ports. The UE further includes a processor operably coupled to the transceiver, the processor, based on the indication, configured to identify the X groups of antenna ports. The transceiver is further configured to transmit an uplink (UL) transmission based on the X groups of antenna ports. When X = 1, the UL transmission corresponds to one physical uplink shared channel (PUSCH) transmission from one of the two groups of antenna ports. When X = 2, the UL transmission corresponds to one or two PUSCH transmissions from the two groups of antenna ports.

In another embodiment, a base station (BS) is provided. The BS includes a transceiver configured to transmit information about at least one SRS-Info that is associated with two groups of antenna ports; transmit an indication indicating X groups of the two groups of antenna ports; and receive an UL transmission based on the X groups of antenna ports. When X = 1, the UL transmission corresponds to one PUSCH transmission from one of the two groups of antenna ports. When X = 2, the UL transmission corresponds to one or two PUSCH transmissions from the two groups of antenna ports.

In yet another embodiment, a method performed by a UE is provided. The method includes receiving information about at least one SRS-Info that is associated with two groups of antenna ports; receiving an indication indicating X groups of the two groups of antenna ports; based on the indication, identifying the X groups of antenna ports; and transmitting an UL transmission based on the X groups of antenna ports. When X = 1, the UL transmission corresponds to one PUSCH transmission from one of the two groups of antenna ports. When X = 2, the UL transmission corresponds to one or two PUSCH transmissions from the two groups of antenna ports.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example antenna blocks or arrays forming beams according to embodiments of the present disclosure;

FIG. 7 illustrates an example antenna panel according to embodiments of the present disclosure;

FIG. 8 illustrates another example antenna panel according to embodiments of the present disclosure;

FIG. 9 illustrates an example antenna port layout according to embodiments of the present disclosure;

FIG. 10 illustrates an uplink transmission scheme according to embodiments of the present disclosure;

FIG. 11 illustrates another uplink transmission scheme according to embodiments of the present disclosure; and

FIG. 12 illustrates a flowchart for a method for utilizing an SRS configuration according to embodiments of the present disclosure.

### DETAILED DESCRIPTION

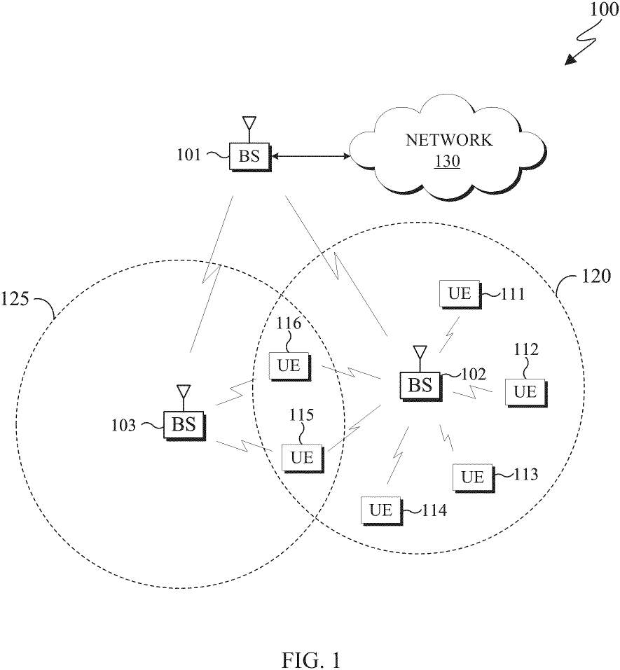

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v17.0.0, “E-UTRA, Medium Access Control (MAC) protocol specification” (herein “REF 4”); 3GPP TS 36.331 v17.0.0, “E-UTRA, Radio Resource Control (RRC) protocol specification” (herein “REF 5”); 3GPP TS 38.211 v17.0.0, “NR, Physical channels and modulation” (herein “REF 6”); 3GPP TS 38.212 v17.0.0, “NR, Multiplexing and Channel coding” (herein “REF 7”); 3GPP TS 38.213 v17.0.0, “NR, Physical Layer Procedures for Control” (herein “REF 8”); 3GPP TS 38.214 v17.0.0, “NR, Physical Layer Procedures for Data” (herein “REF 39); 3GPP TS 38.215 v17.0.0, “NR, Physical Layer Measurements” (herein “REF 10”); 3GPP TS 38.321 v17.0.0, “NR, Medium Access Control (MAC) protocol specification” (herein “REF 11”); 3GPP TS 38.331 v17.0.0, “NR, Radio Resource Control (RRC) Protocol Specification (herein REF 12)”.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.1 1a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station ... “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing an SRS configuration. In certain embodiments, one or more of the BSs 101-103 include circuitry, programing, or a combination thereof for providing an SRS configuration.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

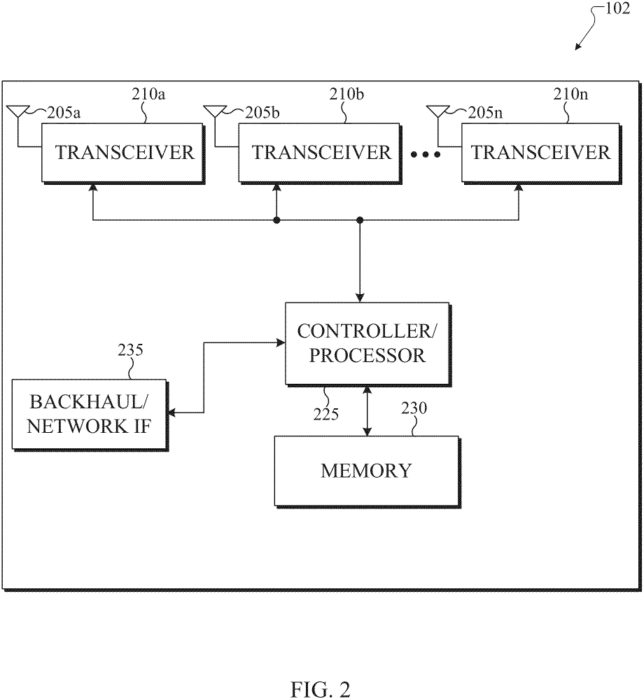

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n downconvert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for providing SRS configuration. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

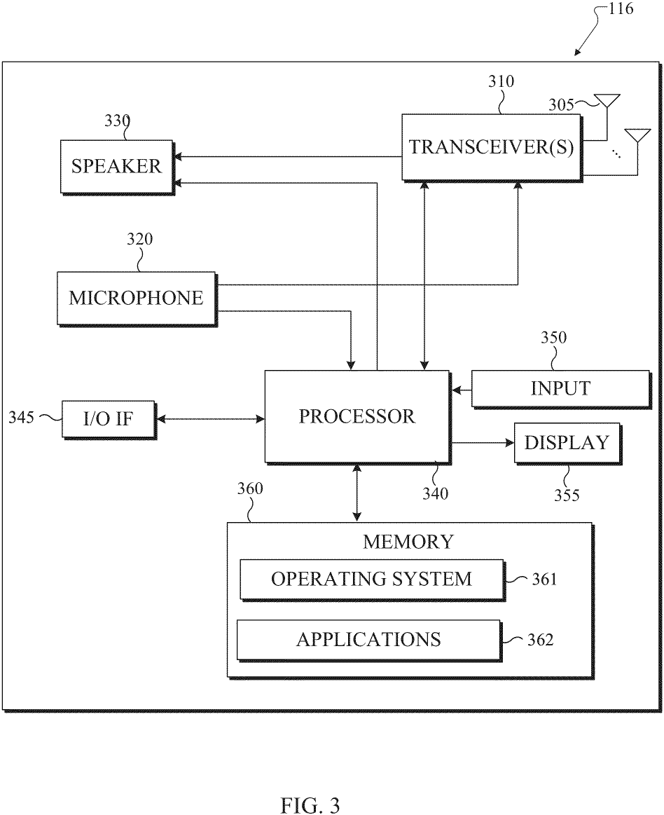

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for utilizing SRS configuration. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

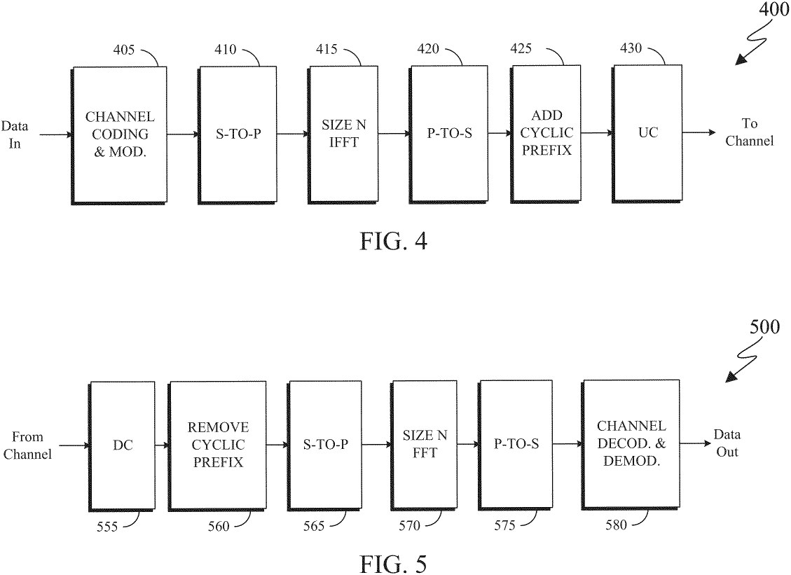

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support SRS configurations as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The 3GPP NR specification supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase. For UL transmission, the 3GPP specification supports 1, 2, or 4 SRS antenna ports in one SRS resource, where each SRS antenna port can be mapped to one or multiple antenna elements at the UE.

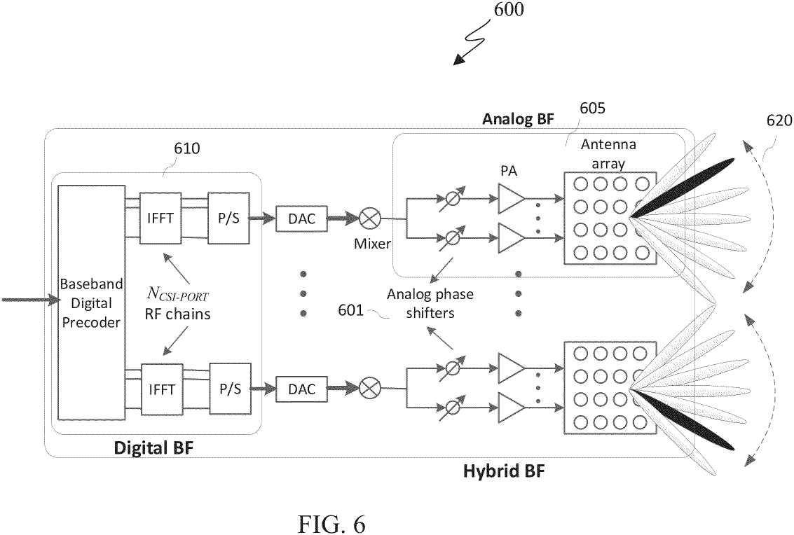

FIG. 6 illustrates an example antenna blocks or arrays 600 according to embodiments of the present disclosure. The embodiment of the antenna blocks or arrays 600 illustrated in FIG. 6 is for illustration only. FIG. 6 does not limit the scope of this disclosure to any particular implementation of the antenna blocks or arrays.

For mmWave bands, although the number of antenna elements can be larger for a given form factor, the number of CSI-RS ports - which can correspond to the number of digitally precoded ports - tends to be limited due to hardware constraints (such as the feasibility to install a large number of ADCs/DACs at mmWave frequencies) as illustrated in FIG. 6. In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration - to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (~ 10 dB additional loss @ 100 m distance), larger number of and sharper analog beams (hence larger number of radiators in the array) will be needed to compensate for the additional path loss.

In NR, two transmission schemes are supported for PUSCH: codebook based transmission and non-codebook based transmission. The UE is configured with codebook based transmission when the higher layer parameter txConfig in pusch-Config is set to ‘codebook’, the UE is configured non-codebook based transmission when the higher layer parameter txConfig is set to ‘nonCodebook’.

According to Section 6.1.1.1 [REF9], the following is supported for codebook based UL transmission.

For codebook based transmission, PUSCH can be scheduled by DCI format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0... v-1} and that corresponds to the SRS resource selected by the SRI when multiple SRS resources are configured, or if a single SRS resource is configured TPMI is used to indicate the precoder to be applied over the layers {0...v-1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fullyAndPartialAndNonCoherent’.

A UE reporting its UE capability of ‘nonCoherent’ transmission shall not expect to be configured by either codebookSubset or codebookSubsetForDCI-Format0-2 with ‘fullyAndPartialAndNonCoherent’ or with ‘partialAndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPowerTransmission set to ‘fullpowerModel’ and codebookSubset or codebookSubsetDCI-0-2 set to ΣulₗAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The DM-RS antenna ports {p̃̅₀, ..., p̃ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for all these SRS resources.

In the remainder of the present disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies all antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset = ‘fullAndPartialAndNonCoherent’, the UL codebook includes all three types (FC, PC, NC) of precoding matrices; when the UE is configured with codebookSubset = ‘partialAndNonCoherent’, the UL codebook includes two types (PC, NC) of precoding matrices; and when the UE is configured with codebookSubset = ‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W - 1 for single-layer transmission on a single antenna port, otherwise by Table 1 to Table 6, which are copied below.

The rank (or number of layers) and the corresponding precoding matrix W are indicated to the UE using TRI and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 1

Precoding matrix w for single-layer transmission using two antenna ports.

| TPMI index | W (ordered from left to right in increasing order of TPMI index) | | | | | | | |
|---|---|---|---|---|---|---|---|---|
| 0-5 | $\frac{1}{\sqrt{2}} \left[\begin{matrix}1 \\ 0\end{matrix}\right]$ | $\frac{1}{\sqrt{2}} \left[\begin{matrix}0 \\ 1\end{matrix}\right]$ | $\frac{1}{\sqrt{2}} \left[\begin{matrix}1 \\ 1\end{matrix}\right]$ | $\frac{1}{\sqrt{2}} \left[\begin{matrix}1 \\ - 1\end{matrix}\right]$ | $\frac{1}{\sqrt{2}} \left[\begin{matrix}1 \\ j\end{matrix}\right]$ | $\frac{1}{\sqrt{2}} \left[\begin{matrix}1 \\ - j\end{matrix}\right]$ | - | - |

TABLE 2

Precoding matrix w for single-layer transmission using four antenna ports with transform precoding disabled.

| TPMI index | W (ordered from left to right in increasing order of TPMI index) | | | | | | | |
|---|---|---|---|---|---|---|---|---|
| 0-7 | $\frac{1}{2} \left[\begin{matrix}1 \\ 0 \\ 0 \\ 0\end{matrix}\right]$ | $\frac{1}{2} \left[\begin{matrix}0 \\ 1 \\ 0 \\ 0\end{matrix}\right]$ | $\frac{1}{2} \left[\begin{matrix}0 \\ 0 \\ 1 \\ 0\end{matrix}\right]$ | $\frac{1}{2} \left[\begin{matrix}0 \\ 0 \\ 0 \\ 1\end{matrix}\right]$ | $\frac{1}{2} \left[\begin{matrix}1 \\ 0 \\ 1 \\ 0\end{matrix}\right]$ | $\frac{1}{2} \left[\begin{matrix}1 \\ 0 \\ - 1 \\ 0\end{matrix}\right]$ | $\frac{1}{2} \left[\begin{matrix}1 \\ 0 \\ j \\ 0\end{matrix}\right]$ | $\frac{1}{2} \left[\begin{matrix}1 \\ 0 \\ - j \\ 0\end{matrix}\right]$ |
| 8-15 | $\frac{1}{2} \left[\begin{matrix}0 \\ 1 \\ 0 \\ 1\end{matrix}\right]$ | $\frac{1}{2} \left[\begin{matrix}0 \\ 1 \\ 0 \\ - 1\end{matrix}\right]$ | $\frac{1}{2} \left[\begin{matrix}0 \\ 1 \\ 0 \\ j\end{matrix}\right]$ | $\frac{1}{2} \left[\begin{matrix}0 \\ 1 \\ 0 \\ - j\end{matrix}\right]$ | $\frac{1}{2} \left[\begin{matrix}1 \\ 1 \\ 1 \\ 1\end{matrix}\right]$ | $\frac{1}{2} \left[\begin{matrix}1 \\ 1 \\ j \\ j\end{matrix}\right]$ | $\frac{1}{2} \left[\begin{matrix}1 \\ 1 \\ - 1 \\ - 1\end{matrix}\right]$ | $\frac{1}{2} \left[\begin{matrix}1 \\ 1 \\ - j \\ - j\end{matrix}\right]$ |
| 16-23 | $\frac{1}{2} \left[\begin{matrix}1 \\ j \\ j \\ 1\end{matrix}\right]$ | $\frac{1}{2} \left[\begin{matrix}1 \\ j \\ j \\ - 1\end{matrix}\right]$ | $\frac{1}{2} \left[\begin{matrix}1 \\ j \\ - 1 \\ - j\end{matrix}\right]$ | $\frac{1}{2} \left[\begin{matrix}1 \\ j \\ - j \\ 1\end{matrix}\right]$ | $\frac{1}{2} \left[\begin{matrix}1 \\ - 1 \\ 1 \\ - 1\end{matrix}\right]$ | $\frac{1}{2} \left[\begin{matrix}1 \\ - 1 \\ j \\ - j\end{matrix}\right]$ | $\frac{1}{2} \left[\begin{matrix}1 \\ - 1 \\ - 1 \\ 1\end{matrix}\right]$ | $\frac{1}{2} \left[\begin{matrix}1 \\ 1 \\ - j \\ j\end{matrix}\right]$ |
| 24-27 | $\frac{1}{2} \left[\begin{matrix}1 \\ - j \\ 1 \\ - j\end{matrix}\right]$ | $\frac{1}{2} \left[\begin{matrix}1 \\ - j \\ j \\ 1\end{matrix}\right]$ | $\frac{1}{2} \left[\begin{matrix}1 \\ - j \\ - 1 \\ j\end{matrix}\right]$ | $\frac{1}{2} \left[\begin{matrix}1 \\ - j \\ - j \\ - 1\end{matrix}\right]$ | - | - | - | - |

TABLE 3

Precoding matrix w for two-layer transmission using two antenna ports with transform precoding disabled.

| TPMI index | W (ordered from left to right in increasing order of TPMI index) | | |
|---|---|---|---|
| 0-2 | $\frac{1}{2} \left[\begin{matrix}1 & 0 \\ 0 & 1\end{matrix}\right]$ | $\frac{1}{2} \left[\begin{matrix}1 & 1 \\ 1 & - 1\end{matrix}\right]$ | $\frac{1}{2} \left[\begin{matrix}1 & 1 \\ j & - j\end{matrix}\right]$ |

TABLE 4

Precoding matrix W for two-layer transmission using four antenna ports with transform precoding disabled.

| TPMI index | W (ordered from left to right in increasing order of TPMI index) | | | |
|---|---|---|---|---|
| 0-3 | $\frac{1}{2} \left[\begin{matrix}1 & 0 \\ 0 & 1 \\ 0 & 0 \\ 0 & 0\end{matrix}\right]$ | $\frac{1}{2} \left[\begin{matrix}1 & 0 \\ 0 & 0 \\ 0 & 1 \\ 0 & 0\end{matrix}\right]$ | $\frac{1}{2} \left[\begin{matrix}1 & 0 \\ 0 & 0 \\ 0 & 0 \\ 0 & 1\end{matrix}\right]$ | $\frac{1}{2} \left[\begin{matrix}0 & 0 \\ 1 & 0 \\ 0 & 1 \\ 0 & 0\end{matrix}\right]$ |
| 4-7 | $\frac{1}{2} \left[\begin{matrix}0 & 0 \\ 1 & 0 \\ 0 & 0 \\ 0 & 1\end{matrix}\right]$ | $\frac{1}{2} \left[\begin{matrix}0 & 0 \\ 0 & 0 \\ 1 & 0 \\ 0 & 1\end{matrix}\right]$ | $\frac{1}{2} \left[\begin{matrix}1 & 0 \\ 0 & 1 \\ 1 & 0 \\ 0 & - j\end{matrix}\right]$ | $\frac{1}{2} \left[\begin{matrix}1 & 0 \\ 0 & 1 \\ 1 & 0 \\ 0 & j\end{matrix}\right]$ |
| 8-11 | $\frac{1}{2} \left[\begin{matrix}1 & 0 \\ 0 & 1 \\ - j & 0 \\ 0 & 1\end{matrix}\right]$ | $\frac{1}{2} \left[\begin{matrix}1 & 0 \\ 0 & 1 \\ - j & 0 \\ 0 & - 1\end{matrix}\right]$ | $\frac{1}{2} \left[\begin{matrix}1 & 0 \\ 0 & 1 \\ - 1 & 0 \\ 0 & - j\end{matrix}\right]$ | $\frac{1}{2} \left[\begin{matrix}1 & 0 \\ 0 & 1 \\ - 1 & 0 \\ 0 & j\end{matrix}\right]$ |
| 12-15 | $\frac{1}{2} \left[\begin{matrix}1 & 0 \\ 0 & 1 \\ j & 0 \\ 0 & 1\end{matrix}\right]$ | $\frac{1}{2} \left[\begin{matrix}1 & 0 \\ 0 & 1 \\ j & 0 \\ 0 & - 1\end{matrix}\right]$ | $\frac{1}{2 \sqrt{2}} \left[\begin{matrix}1 & 1 \\ 1 & 1 \\ 1 & - 1 \\ 1 & - 1\end{matrix}\right]$ | $\frac{1}{2 \sqrt{2}} \left[\begin{matrix}1 & 1 \\ 1 & 1 \\ j & - j \\ j & - j\end{matrix}\right]$ |
| 16 - 19 | $\frac{1}{2 \sqrt{2}} \left[\begin{matrix}1 & 1 \\ j & j \\ 1 & - 1 \\ j & - j\end{matrix}\right]$ | $\frac{1}{2 \sqrt{2}} \left[\begin{matrix}1 & 1 \\ j & j \\ j & - j \\ - 1 & - 1\end{matrix}\right]$ | $\frac{1}{2 \sqrt{2}} \left[\begin{matrix}1 & 1 \\ - 1 & - 1 \\ 1 & - 1 \\ - 1 & - 1\end{matrix}\right]$ | $\frac{1}{2 \sqrt{2}} \left[\begin{matrix}1 & 1 \\ - 1 & - 1 \\ j & - j \\ - j & j\end{matrix}\right]$ |
| 20-21 | $\frac{1}{2 \sqrt{2}} \left[\begin{matrix}1 & 1 \\ - j & - j \\ 1 & - 1 \\ - j & j\end{matrix}\right]$ | $\frac{1}{2 \sqrt{2}} \left[\begin{matrix}1 & 1 \\ - j & - j \\ j & - j \\ 1 & - 1\end{matrix}\right]$ | - | - |

TABLE 5

Precoding matrix W for three-layer transmission using four antenna ports with transform precoding disabled.

| TPMI index | W (ordered from left to right in increasing order of TPMI index) | | | |
|---|---|---|---|---|
| 0-3 | $\frac{1}{2} \left[\begin{matrix}1 & 0 & 0 \\ 0 & 1 & 0 \\ 0 & 0 & 1 \\ 0 & 0 & 0\end{matrix}\right]$ | $\frac{1}{2} \left[\begin{matrix}1 & 0 & 0 \\ 0 & 1 & 0 \\ 1 & 0 & 0 \\ 0 & 0 & 1\end{matrix}\right]$ | $\frac{1}{2} \left[\begin{matrix}1 & 0 & 0 \\ 0 & 1 & 0 \\ - 1 & 0 & 0 \\ 0 & 0 & 1\end{matrix}\right]$ | $\frac{1}{2 \sqrt{3}} \left[\begin{matrix}1 & 1 & 1 \\ 1 & - 1 & 1 \\ 1 & 1 & - 1 \\ 1 & - 1 & - 1\end{matrix}\right]$ |
| 4-6 | $\frac{1}{2 \sqrt{3}} \left[\begin{matrix}1 & 1 & 1 \\ 1 & - 1 & 1 \\ j & j & - j \\ j & - j & - j\end{matrix}\right]$ | $\frac{1}{2 \sqrt{3}} \left[\begin{matrix}1 & 1 & 1 \\ - 1 & 1 & - 1 \\ 1 & 1 & - 1 \\ - 1 & 1 & 1\end{matrix}\right]$ | $\frac{1}{2 \sqrt{3}} \left[\begin{matrix}1 & 1 & 1 \\ - 1 & 1 & - 1 \\ j & j & - j \\ - j & j & j\end{matrix}\right]$ | - |

TABLE 6

Precoding matrix W for four-layer transmission using four antenna ports with transform precoding disabled.

| TPMI index | W (ordered from left to right in increasing order of TPMI index) | | | |
|---|---|---|---|---|
| 0-3 | $\frac{1}{2} \left[\begin{matrix}1 & 0 & 0 & 0 \\ 0 & 1 & 0 & 0 \\ 0 & 0 & 1 & 0 \\ 0 & 0 & 0 & 1\end{matrix}\right]$ | $\frac{1}{2 \sqrt{2}} \left[\begin{matrix}1 & 1 & 0 & 0 \\ 0 & 0 & 1 & 1 \\ 1 & - 1 & 0 & 0 \\ 0 & 0 & 1 & - 1\end{matrix}\right]$ | $\frac{1}{2 \sqrt{2}} \left[\begin{matrix}1 & 1 & 0 & 0 \\ 0 & 0 & 1 & 1 \\ j & - j & 0 & 0 \\ 0 & 0 & j & - j\end{matrix}\right]$ | $\frac{1}{4} \left[\begin{matrix}1 & 1 & 1 & 1 \\ 1 & - 1 & 1 & - 1 \\ 1 & 1 & - 1 & - 1 \\ 1 & - 1 & - 1 & 1\end{matrix}\right]$ |
| 4 | $\frac{1}{4} \left[\begin{matrix}1 & 1 & 1 & 1 \\ 1 & - 1 & 1 & - 1 \\ j & j & - j & - j \\ j & - j & - j & j\end{matrix}\right]$ | - | - | - |

The subset of TPMI indices for the three coherence types are summarized in Table 7 and Table 8, where rank = r corresponds to (and is equivalent to) r layers.

TABLE 7

Total power of precoding matrix W for 2 antenna ports

| Rank | Non-Coherent (NC) TPMIs | | Full-Coherent (FC) TPMIs | |
|---|---|---|---|---|
| | TPMI indices | Total power | TPMI indices | Total power |
| 1 | 0-1 | V2 | 2-5 | 1 |
| 2 | 0 | 1 | 1-2 | 1 |

TABLE 8

Total power of precoding matrix W for 4 antenna ports

| Rank | Non-Coherent (NC) TPMIs | | Partial-Coherent (PC) TPMIs | | Full-Coherent (FC) TPMIs | |
|---|---|---|---|---|---|---|
| | TPMI indices | Total power | TPMI indices | Total power | TPMI indices | Total power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9

TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 10

TPMI indices for codebookSubsets for 4 antenna ports

| Rank | Non-Coherent | partialAndNonCoherent | fullAndPartialAndNonCoherent |
|---|---|---|---|
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

The term ‘antenna panel’ refers to a group of antenna ports or a group of antenna elements or a subset of antenna ports associated with a resource (e.g., SRS resource, CSI-RS resource, SSB block).

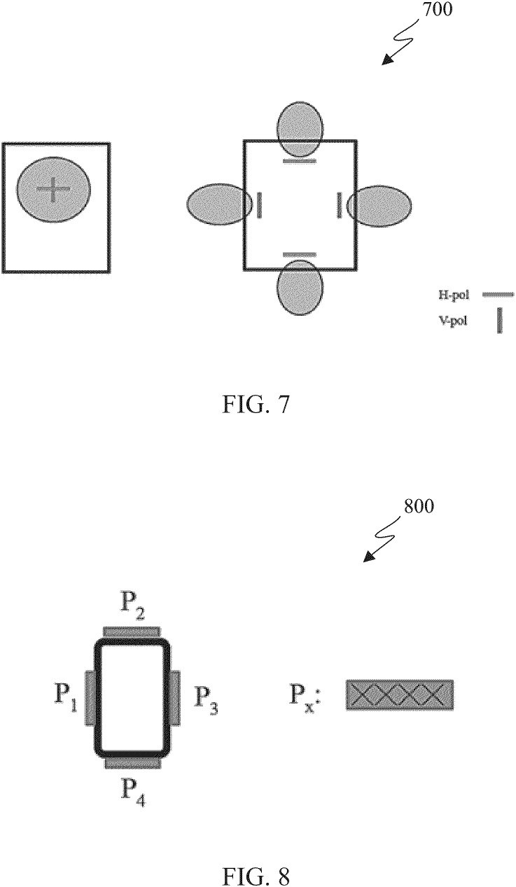

FIG. 7 illustrates an example antenna panel 700 according to embodiments of the present disclosure. The embodiment of the antenna panel 700 illustrated in FIG. 7 is for illustration only. FIG. 7 does not limit the scope of this disclosure to any particular implementation of the antenna panel.

FIG. 8 illustrates another example antenna panel 800 according to embodiments of the present disclosure. The embodiment of the antenna panel 800 illustrated in FIG. 8 is for illustration only. FIG. 8 does not limit the scope of this disclosure to any particular implementation of the antenna panel.

Two examples are shown in FIG. 7. The first example has a single panel comprising a dual-polarized (i.e., two) antennae/ports, and the second example has four panels each comprising a single antenna/ports (pointing in four different directions). Another example is shown in FIG. 8 wherein there are four antenna panels (on opposite sides), each comprising four dual-polarized antennae/ports.

For a UE equipped with multiple antenna panels, the UE can be configured with the following reporting to facilitate panel selection (1 out of multiple panel selection) or simultaneous (UL) transmission from multiple panels.
The UE can report a correspondence between a CSI-RS or SSB resource index and a UE capability value (or value set). This report can be via a beam/CSI report. Also, this reporting can correspond to an index or indicator or identifier (ID).
The UE capability value (or value set) belongs to a list of UE capability values (or value sets). The list can be reported via UE capability reporting.

A few examples of the UE capability value are as follows.
V₁: The UE capability value corresponds to a maximum supported number of SRS ports. In one example, the candidate values include {1,2,4} or {1,2,3,4}, or {1,2,4,6}, or {1,2,4,8}, or {1,2,...,N}, where N is the total (max) number of SRS ports at the UE (or the UE can support).
V₂: The UE capability value corresponds to a maximum number of layers or rank value. In one example, the candidate values include {1,...,L}, where L is the total (max) number of layers that the UE can support.
V₃: The UE capability value corresponds to a coherence type. In one example, the candidate values include {NC, PC, FC}.
V₄: The UE capability value corresponds to one or multiple TPMIs or a TPMI group. In one example, the candidate values include the TPMI indices from the Rel. 15 NR UL codebooks for N=2 and 4 ports, or an UL codebook for N>4 (e.g., N=6 or 8).

The capability value can convey an information about UE antenna panels. For example, for a UE with 2 panels each with 2 SRS ports, the capability value = 2 SRS ports can indicate one panel, and the capability value = 4 SRS ports can indicate two panels.

In one example, a UE capability value set comprises a pair (Vᵢ₁, Vᵢ₂), where (i₁, i₂) ∈ {(1,2), (1,3), (1,4), (2,3), (2,4), (3,4)} and Vᵢ is according to one of the examples above.

In one example, a UE capability value set comprises a tuple of N values (Vᵢ₁, ..., V_{iN}), where each of i₁, ..., i_{N} ∈ {1, ...,4} and Vᵢ is according to one of the examples above. Here N ≥ 2.

In one example, for a UE equipped with multiple panels, a panel entity can also correspond to (or be associated with or indicated via) at least one of the following quantities/entities.
In one example, a panel corresponds to a panel ID.
In one example, a panel corresponds to a resource ID (e.g., SRS resource ID, CSI-RS resource ID, SSB resource ID).
In one example, a panel corresponds to a resource set ID (e.g., SRS resource set ID, CSI-RS resource set ID, SSB resource set ID).
In one example, a panel corresponds to a max supported number of SRS ports (indicated/reported by the UE, e.g., via beam report), as described above in V₁.
In one example, a panel corresponds to a max supported number of layers (indicated/reported by the UE, e.g., via beam report), as described above in V₂.
In one example, a panel corresponds to a coherence type (indicated/reported by the UE, e.g., via beam report), as described above in V₃.
In one example, a panel corresponds to a TPMI (indicated/reported by the UE, e.g., via beam report), as described above in V₄.
In one example, a panel corresponds to a pair (Vᵢ₁, Vᵢ₂), as described above.
In one example, a panel corresponds to a tuple (Vᵢ₁, ..., V_{iN}), as described above.

In the present disclosure, simultaneous multi-panel UL transmission from a UE with multiple antenna panels to a single TRP (sTRP) or multiple TRPs (mTRP) is considered. In particular, the following aspects have been discussed.
SRS configuration including one or multiple groups including SRS related information
Examples of groups G₁, G₂, G₃, G₁₂
Examples of SRS-Info, e.g., SRS resources, groups of SRS ports
Examples of SP (from 1 panel) or STx2P (from 2 panel) to 1 TRP or 2 TRPs

In Rel.17 PUSCH transmission (e.g., PUSCH repetition, cf. Section 6.1.2.1, REF9) to multiple (e.g., up to 2 TRPs) is supported via the following components in the specification.
The UE can be configured with 2 SRS resource sets (e.g., 1 per TRP), e.g., via srs-ResourceSetToAddModList or srs-ResourceSetToAddModListDCI-0-2 with higher layer parameter usage in SRS-ResourceSet set to ‘codebook’ or ‘nonCodebook’. The configured SRS resource sets are subject to the following restrictions:
   The same number of SRS resources can be configured in each set.
   The same number SRS ports can be configured in each SRS resource across all sets.

A summary of the supported components is provided in Table 11.

TABLE 11

| | | |
|---|---|---|
| Components | New DCI fields | Purpose |
| Multiple SRS sets | SRS resource set indicator | Dynamic switch between sTRP and mTRP |
| 2 SRIs | Second SRI (1st SRI = Rel. 15/16 based) | DCI indicates 1 or 2 SRIs |
| 2 TPMIs | Second TPMI (1st TPMI = Rel. 15/16 based) | DCI indicates 1 or 2 TPMIs |
| Restriction: same number of layers | Second SRI or second TPMI corresponds to the same number of layers as first SRI or first TPMI, respectively | PUSCH repetition |

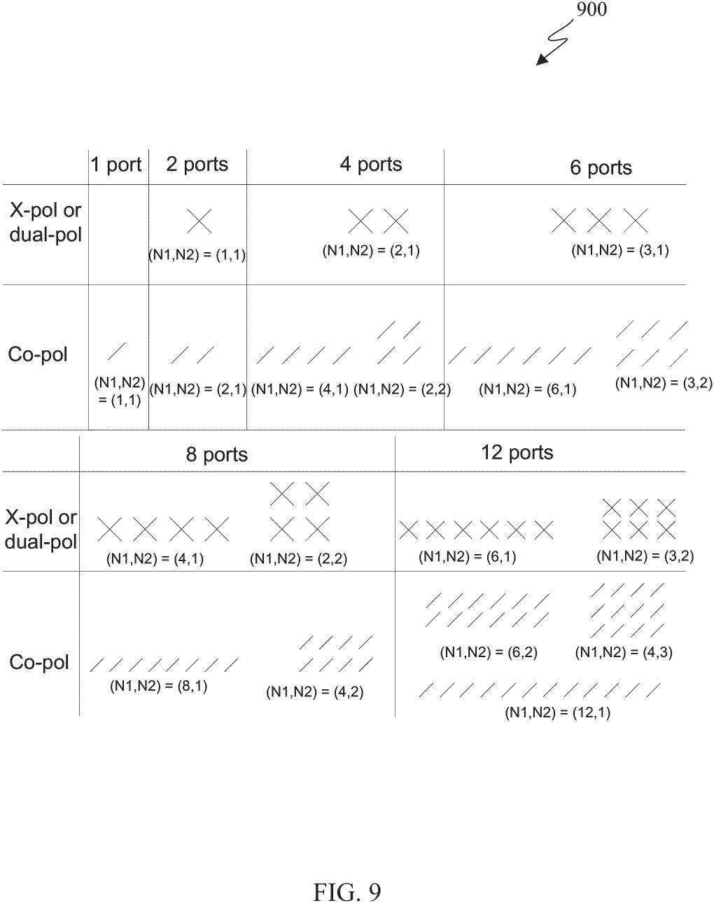

In an antenna panel, let N₁ and N₂ be the number of antenna ports with the same polarization in the first and second dimensions, respectively. For 2D antenna port layouts, we have N₁ > 1, N₂ > 1, and for 1D antenna port layouts, we either have N₁ > 1 and N₂ = 1 or N₂ > 1 and N₁ = 1. In the rest of the present disclosure, 1D antenna port layouts with N₁ > 1 and N₂ = 1 is considered. The present disclosure, however, is applicable to the other 1D port layouts with N₂ > 1 and N₁ = 1. Also, in the rest of the present disclosure, we assume that N₁ ≥ N₂. The present disclosure, however, is applicable to the case when N₁ < N₂, and the embodiments for N₁ > N₂ applies to the case N₁ < N₂ by swapping/switching (N₁,N₂) with (N₂,N₁). For a (single-polarized) co-polarized antenna port layout, the total number of antenna ports is N₁N₂ and for a dual-polarized antenna port layout, the total number of antenna ports is 2N₁N₂. An illustration of antenna port layouts for {1,2, 4, 6, 8, 12} antenna ports at UE is shown in FIG. 9.

FIG. 9 illustrates an example antenna port layout 900 according to embodiments of the present disclosure. The embodiment of the antenna port layout 900 illustrated in FIG. 9 is for illustration only. FIG. 9 does not limit the scope of this disclosure to any particular implementation of the antenna port layout.

Let s denote the number of antenna polarizations (or groups of antenna ports with the same polarization). Then, for co-polarized antenna ports, s = 1, and for dual- or cross (X)-polarized antenna ports s = 2. So, the total number of antenna ports P = sN₁N₂. In one example, the antenna ports at the UE refers to SRS antenna ports (either in one SRS resource or across multiple SRS resources).

We assume all antenna ports of the UE belonging to a single antenna panel are co-located, for example, at one plane, side, or edge of the UE. For a UE equipped with multiple antenna panels, any two panels can be separated and located at different locations such as sides or edges or corners or on front or back sides. Each antenna panel can be assumed to have a structure as shown in FIG. 9.

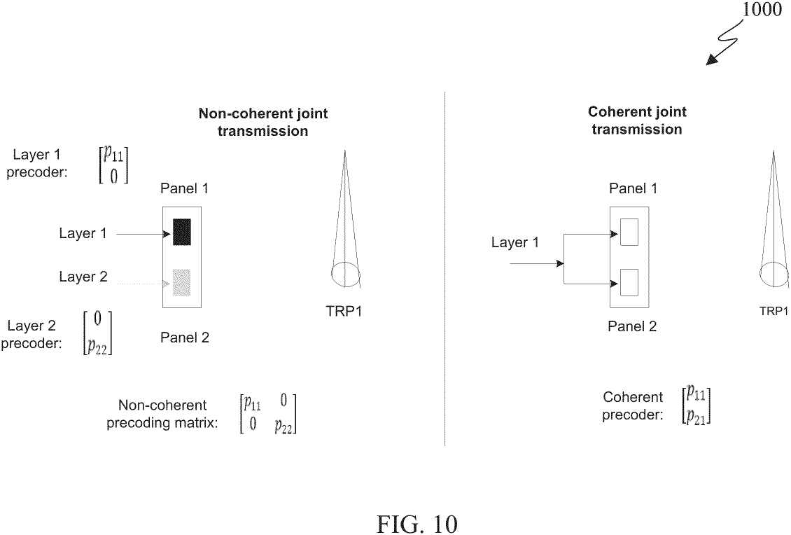

FIG. 10 illustrates an uplink transmission scheme 1000 according to embodiments of the present disclosure. The embodiment of the uplink transmission scheme 1000 illustrated in FIG. 10 is for illustration only. FIG. 10 does not limit the scope of this disclosure to any particular implementation of the uplink transmission scheme.

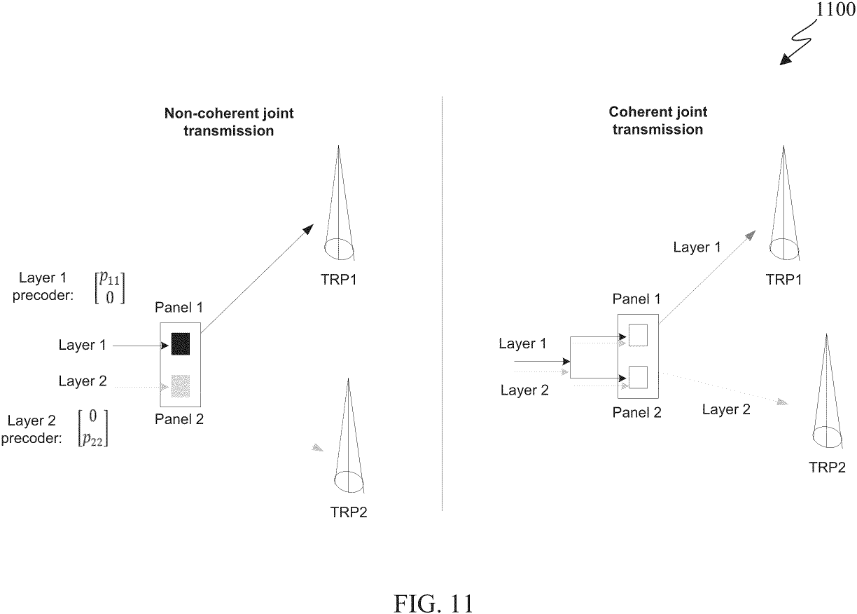

FIG. 11 illustrates another uplink transmission scheme 1100 according to embodiments of the present disclosure. The embodiment of the uplink transmission scheme 1100 illustrated in FIG. 11 is for illustration only. FIG. 11 does not limit the scope of this disclosure to any particular implementation of the uplink transmission scheme.

In one embodiment, a UE equipped with X > 1 antenna panels (e.g., X = 2) is configured with (via RRC) or granted (via UL-DCI, e.g., format 0_1 or 0_2 in NR specification) an UL transmission e.g., PUSCH transmission, where the UL transmission can be transmitted simultaneously from multiple panels (STxMP) or a single panel (SP) to a single TRP (sTRP) or two TRPs (mTRP). In one example, the UL transmission to a single TRP corresponds to 1 PUSCH transmission, and the UL transmission to two TRPs corresponds to 2 PUSCH transmissions. Two examples are illustrated in FIG. 10 and FIG. 11.

In one embodiment, a UE is configured with one or multiple of G₁, G₂, G₃, and G₁₂ where
G₁ comprises a first SRS-related information (abbreviated as SRS-Info),
G₂ comprises a second SRS-Info,
G₃ comprises a third SRS-Info, and
G₁,₂ comprises a pair of (or two) SRS-Infos.

In one example, Gᵢ where i = 1,2 can be associated with i-th Tx-Rx entity at the UE, and G₃ or G₁,₂ can be associated with a pair (1^{st}, 2^{nd}) of Tx-Rx entities at the UE, where a Tx-Rx entity can be an antenna panel, or a group of antenna ports, or a group of RF/digital chains. For example, when a Tx-Rx entity corresponds to an antenna panel, G₁ can be associated with panel 1, G₂ can be associated with panel 2, and G₃ or G₁,₂ can be associated panels 1 and 2.

In one example, the UE is configured to use Gᵢ when the UE selects i-th Tx-Rx entity for UL transmission (and/or DL reception). When a Tx-Rx entity corresponds to an antenna panel, this corresponds to a single panel (SP) selection. Likewise, the UE is configured to use G₃ or G₁₂ when the UE selects both (1^{st}, 2^{nd}) Tx-Rx entites for UL transmission (and/or DL reception). When a Tx-Rx entity corresponds to an antenna panel, for UL, this corresponds to simultaneous transmission from 2 panels (STx2P).

In one embodiment, a UE is configured with G₁, G₂, and G₁₂ where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group,
G₂ comprises a second SRS-Info, which corresponds to a second group of SRS resources G₂ = {s₂(i₂): i₁ = 0,1, ..., k₂ - 1} where s₂(i₂) corresponds to i₂-th SRS resource in the second group and
G₁,₂ comprises a pair of (or two) SRS-Infos, which corresponds to a group of SRS resource pairs
$${G}_{12} = \left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} , \text{where} {s}_{12}^{\left(1\right)} \left({i}_{12}\right) \text{and} {s}_{12}^{\left(2\right)} \left({i}_{12}\right)$$
correspond to 1^{st} and 2^{nd} SRS resource of the i₁₂-th SRS resource pair. Or, G₁,₂ corresponds to a pair of groups G₁₂ =
$$\left\{{G}_{12}^{\left(1\right)} , {G}_{12}^{\left(2\right)}\right\} , \text{where} {G}_{12}^{\left(k\right)} = \left\{{s}_{12}^{\left(k\right)} \left({i}_{k}\right)\right)$$
: iₖ = 0,1, ..., lₖ - 1}, for k = 1,2, and
$${s}_{12}^{\left(k\right)} \left({i}_{k}\right)$$
corresponds to iₖ-th SRS resource in the k-th group.

In one example, for a UE equipped with a total of N antenna ports, G₁ includes k₁ SRS resources each with N₁ SRS ports, G₂ includes k₂ SRS resources each with N₁ SRS ports, and G₁₂ includes k₁₂ pairs of SRS resources, each with N₁ SRS ports. The UE can be indicated with (e.g., via SRI or new indicator) a N₁-port SRS resource from G₁/G₂ (e.g., in case of single panel selection) or a pair of N₁-port SRS resources from G₁₂ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) all three G₁, G₂, and G₁₂.

In one example, a UE is configured with three SRS resource sets comprising/including or (being associated with) each of the three G₁, G₂, and G₁₂, i.e., a first SRS resource set comprises/includes (or being associated with) G₁, a second SRS resource set comprises/includes (or being associated with) G₂, and a third SRS resource set comprises/includes (or being associated with) G₁₂.

In one example, a UE is configured with two SRS resource sets comprising/including or (being associated with) G₁, G₂, and G₁₂.
In one example, a first SRS resource set comprises/includes (or being associated with) G₁ and G₂, and a second SRS resource set comprises/includes (or being associated with) G₁₂.
In one example, a first SRS resource set comprises/includes (or being associated with) G₁ and G₁₂, and a second SRS resource set comprises/includes (or being associated with) G₂.
In one example, a first SRS resource set comprises/includes (or being associated with) G₁₂ and G₂, and a second SRS resource set comprises/includes (or being associated with) G₁.

The UE can be configured with a reporting (e.g., beam or CSI reporting via higher layer CSI-ReportConfig), wherein the reporting includes an information about one or multiple of G₁, G₂, and G₁₂. For instance, the UE can report the information about G₁ or G₂ when the UE reports a single panel selection (e.g., for UL), and the UE can report the information about G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₂ or a pair of SRS resources from G₁₂. This indication can be via SRI taking a value from 0,1, ..., k₁ + k₂ + k₁₂ - 1. Or, this indication can be via two indicators, a first indicator indicating one of G₁, G₂, and G₁₂, and a second indicator indicating a SRS resource (if the first indicator indicates one of G₁ and G₂) or a pair SRS resources (if the first indicator indicates G₁₂).
In one example, the UE is indicated with a SRS resource (index i) from G₁ or G₂, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ + k₂ - 1} and j ∈ {0,1, ..., k₁₂ - 1}.
In one example, the UE is indicated with a SRS resource (index i ∈ {0,1, ..., k₁ - 1}) from G₁, a SRS resource (index k ∈ {0,1, ..., k₂ - 1}) from G₂, and a pair of SRS resources (index j ∈ {0,1, ..., k₁₂ - 1}) from G₁₂. This indication can be via a joint SRI indicating (i, k, j ) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k, i).

In one example, the UE can be configured or indicated with
sTRP scheme 1: SRS resource(s) from G₁ or G₂ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) transmissions can be dynamic (e.g., via UL-DCI format 0_1 or 0_2) or MAC CE or semi-static (e.g., via higher layer).

In one embodiment, a UE is configured with G₁, G₂, and G₃ where
G₁ comprises a first SRS-Info, which corresponds to a first group of SRS resources G₁ = {s₁(i₁): i₁ = 0,1, ..., k₁ - 1} where s₁(i₁) corresponds to i₁ -th SRS resource in the first group,
G₂ comprises a second SRS-Info, which corresponds to a second group of SRS resources G₂ = {s₂(i₂): i₁ = 0,1, ..., k₂ - 1} where s₂(i₂) corresponds to i₂-th SRS resource in the second group and
G₃ comprises a third SRS-Info, which corresponds to a third group of SRS resources G₃ = {s₃(i₃): i₃ = 0,1, ..., k₃ - 1} where s₃(i₃) corresponds to i₃-th SRS resource in the third group.

In one example, for a UE equipped with a total of N antenna ports, G₁ and G₂ comprise k₁ and k₂ SRS resources, respectively, each with N₁ SRS ports (e.g., associated with panels 1 and 2, respectively), and G₃ comprises k₃ SRS resources, each with N ports (e.g., associated with both panels). The UE can be indicated with (e.g., via SRI or new indicator) a N₁-port SRS resource from G₁/G₂ (e.g., in case of single panel selection) or a N-port SRS resource from G₃ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) all three G₁, G₂, and G₃.

In one example, a UE is configured with three SRS resource sets comprising/including or (being associated with) each of the three G₁, G₂, and G₃, i.e., a first SRS resource set comprises/includes (or being associated with) G₁, a second SRS resource set comprises/includes (or being associated with) G₂, and a third SRS resource set comprises/includes (or being associated with) G₃.

In one example, a UE is configured with two SRS resource sets comprising/including or (being associated with) G₁, G₂, and G₃.
In one example, a first SRS resource set comprises/includes (or being associated with) G₁ and G₂, and a second SRS resource set comprises/includes (or being associated with) G₃.
In one example, a first SRS resource set comprises/includes (or being associated with) G₁ and G₃, and a second SRS resource set comprises/includes (or being associated with) G₂.
In one example, a first SRS resource set comprises/includes (or being associated with) G₃ and G₂, and a second SRS resource set comprises/includes (or being associated with) G₁.

The UE can be configured with a reporting (e.g., beam or CSI reporting via higher layer CSI-ReportConfig), wherein the reporting includes an information about one or multiple of G₁, G₂, and G₃. For instance, the UE can report the information about G₁ or G₂ when the UE reports a single panel selection (e.g., for UL), and the UE can report the information about G₃ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₂ or G₃. This indication can be via SRI taking a value from 0,1, ..., k₁ + k₂ + k₃ - 1. Or, this indication can be via two indicators, a first indicator indicating one of G₁, G₂, and G₃, and a second indicator indicating a SRS resource from the group indicated via the first indicator.
In one example, the UE is indicated with a SRS resource (index i) from G₁ or G₂, and a SRS resource (index j) from G₃. This indication can be via a joint SRI indicating (i,j) or via two separate SRIs, SRI1 indicating i and SRI2 indicating j, where i ∈ {0,1, ..., k₁ + k₂ -1} and j E {0,1, ..., k₃ - 1}.
In one example, the UE is indicated with a SRS resource (index i ∈ {0,1, ..., k₁ - 1}) from G₁, a SRS resource (index k ∈ {0,1, ..., k₂ - 1}) from G₂, and a SRS resource (index j ∈ {0,1, ..., k₃ - 1}) from G₃. This indication can be via a joint SRI indicating (i,k,j) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k, i).

In one example, the UE can be configured or indicated with
sTRP scheme 1: SRS resource(s) from G₁ or G₂ for an UL transmission using N₁ ports (e.g., 1 PUSCH transmitted to 1 TRP using 1 panel), or
sTRP scheme 3: SRS resource(s) from G₃ for an UL transmission using N ports (e.g., 1 PUSCH transmission to 1 TRP using 2 panels).

This switching between N₁-port (1 panel) and N-port (2 panels) UL transmissions can be dynamic (e.g., via UL-DCI format 0_1 or 0_2) or MAC CE or semi-static (e.g., via higher layer). In one example, this N₁-port or N-port UL transmission can be for a single PUSCH (directed towards a single TRP).

In one embodiment, a UE is configured with G₁, G₂, G₃, and G₁₂ where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group,
G₂ comprises a second SRS-Info, which corresponds to a second group of SRS resources G₂ = {s₂(i₂): i₁ = 0,1, ..., k₂ - 1} where s₂(i₂) corresponds to i₂-th SRS resource in the second group,
G₃ comprises a third SRS-Info, which corresponds to a third group of SRS resources G₃ = {s₃(i₃): i₃ = 0,1, ..., k₃ - 1} where s₃(i₃) corresponds to i₃-th SRS resource in the third group.
G₁,₂ comprises a pair of (or two) SRS-Infos, which corresponds to a group of SRS resource pairs G₁₂ =
$$\begin{matrix}\left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} , \\ \text{where} {s}_{12}^{\left(1\right)} \left({i}_{12}\right) \text{and} {s}_{12}^{\left(2\right)} \left({i}_{12}\right)\end{matrix}$$
correspond to 1^{st} and 2^{nd} SRS resource of the i₁₂-th SRS resource pair. Or, G₁,₂ corresponds to a pair of groups G₁₂ =
$$\left\{{G}_{12}^{\left(1\right)} , {G}_{12}^{\left(2\right)}\right\} , \text{where} {G}_{12}^{\left(k\right)} = \left\{{s}_{12}^{\left(k\right)}\right)$$
(iₖ): iₖ = 0,1, ..., lₖ - 1}, for k = 1,2, and
$${s}_{12}^{\left(k\right)}$$
(iₖ) corresponds to iₖ-th SRS resource in the k-th group.

In one example, for a UE equipped with a total of N antenna ports, G₁ includes k₁ SRS resources each with N₁ SRS ports, G₂ includes k₂ SRS resources each with N₁ SRS ports, G₃ includes k₃ SRS resources each with N SRS ports, and G₁₂ includes k₁₂ pairs of SRS resources, each with N₁ SRS ports. The UE can be indicated with (e.g., via SRI or new indicator) a N₁-port SRS resource from G₁/G₂ (e.g., in case of single panel selection), or a N-port SRS resource from G₃ (e.g., in case of STx2P), or a pair of N₁-port SRS resources from G₁₂ (e.g., in case of STx2P). Here, N > N₁. In one example, (N, N₁) = (8,4), (8,2), (8,1), (4,2), (4,1), or (2,1).

In one example, a UE is configured with a SRS resource set comprising/including or (being associated with) all four G₁, G₂, G₃, and G₁₂.

In one example, a UE is configured with four SRS resource sets comprising/including or (being associated with) each of the three G₁, G₂, G₃, and G₁₂, i.e., a first SRS resource set comprises/includes (or being associated with) G₁, a second SRS resource set comprises/includes (or being associated with) G₂, a third SRS resource set comprises/includes (or being associated with) G₃, and a fourth SRS resource set comprises/includes (or being associated with) G₁₂.

In one example, a UE is configured with two SRS resource sets comprising/including or (being associated with) G₁, G₂, G₃, and G₁₂ .
In one example, a first SRS resource set comprises/includes (or being associated with) G₁ and G₂, and a second SRS resource set comprises/includes (or being associated with) G₃ and G₁₂.
In one example, a first SRS resource set comprises/includes (or being associated with) G₁ and G₁₂, and a second SRS resource set comprises/includes (or being associated with) G₂ and G₃.
In one example, a first SRS resource set comprises/includes (or being associated with) G₁ and G₃, and a second SRS resource set comprises/includes (or being associated with) G₂ and G₁₂.
In one example, a first SRS resource set comprises/includes (or being associated with) G₁, G₂ and G₃, and a second SRS resource set comprises/includes (or being associated with) G₁₂.
In one example, a first SRS resource set comprises/includes (or being associated with) G₁, G₂ and G₁₂, and a second SRS resource set comprises/includes (or being associated with) G₃.
In one example, a first SRS resource set comprises/includes (or being associated with) G₁, G₃ and G₁₂, and a second SRS resource set comprises/includes (or being associated with) G₂.
In one example, a first SRS resource set comprises/includes (or being associated with) G₂, G₃ and G₁₂, and a second SRS resource set comprises/includes (or being associated with) G₁.

The UE can be configured with a reporting (e.g., beam or CSI reporting via higher layer CSI-ReportConfig), wherein the reporting includes an information about one or multiple of G₁, G₂, G₃, and G₁₂. For instance, the UE can report the information about G₁ or G₂ when the UE reports a single panel selection (e.g., for UL), and the UE can report the information about G₃ or G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₂ or G₃ or a pair of SRS resources from G₁₂. This indication can be via SRI taking a value from 0,1, ..., k₁ + k₂ + k₃ + k₁₂ - 1. Or, this indication can be via two indicators, a first indicator indicating one of G₁, G₂, G₃, and G₁₂, and a second indicator indicating a SRS resource or a pair of SRS resources from the group indicated via the first indicator.
In one example, the UE is indicated with a SRS resource (index i) from G₁ or G₂ or G₃, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ + k₂ + k₃ - 1} and j ∈ {0,1, ..., k₁₂ - 1}.
In one example, the UE is indicated with a SRS resource (index i ∈ {0,1, ..., k₁ + k₂ - 1}) from G₁ or G₂, a SRS resource (index k ∈ {0,1, ..., k₃ -1}) from G₃, and a pair of SRS resources (index j ∈ {0,1, ..., k₁₂ - 1}) from G₁₂. This indication can be via a joint SRI indicating (i,k,j) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k, i).
In one example, the UE is indicated with a SRS resource (index i ∈ {0,1, ..., k₁ - 1}) from G₁, a SRS resource (index l ∈ {0,1, ..., k₁ - 1}) from G₂, a SRS resource (index k ∈ {0,1, ..., k₃ - 1}) from G₃, and a pair of SRS resources (index j ∈ {0,1, ..., k₁₂ - 1}) from G₁₂. This indication can be via a joint SRI, or via two SRIs, or three SRIs, or four SRIs.

In one example, the UE can be configured or indicated with
sTRP scheme 1: SRS resource(s) from G₁ or G₂ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
sTRP scheme 3: SRS resource(s) from G₃ for an UL transmission using N ports (e.g., 1 PUSCH transmission to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁, G₂, G₃, and G₁₂, wherein
G₁ or G₂ can be used/configured for a single panel (out of multiple panels) selection based UL transmission (e.g., 1 PUSCH transmission from 1 panel towards 1 TRP), and
G₁₂ or G₃ can be used/configured for STx2P based UL transmission. In one example, G₃ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with pair of SRS resources for the UL transmission based on G₁₂, then the UL transmission is for mTRP (e.g., 2 PUSCHs). In this case, the pair of SRS resources can be indicated via two SRI (e.g., SRI and second SRI fields in UL-DCI format 0_1 or 0_2).

In one example, the UE is configured with SRS resource(s) for the UL transmission based on G₁, G₂, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁, G₃, and G₁₂, where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group,
G₃ comprises a third SRS-Info, which corresponds to a third group of SRS resources G₃ = {s₃(i₃): i₃ = 0,1, ..., k₃ - 1} where s₃(i₃) corresponds to i₃-th SRS resource in the third group, and
G₁,₂ comprises a pair of (or two) SRS-Infos, which corresponds to a group of SRS resource pairs
$$\begin{matrix}{G}_{12} = \left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} , \\ \text{where} {s}_{12}^{\left(1\right)} \left({i}_{12}\right) \text{and} {s}_{12}^{\left(2\right)} \left({i}_{12}\right)\end{matrix}$$
correspond to 1^{st} and 2^{nd} SRS resource of the i₁₂-th SRS resource pair. Or, G₁,₂ corresponds to a pair of groups
$${G}_{12} = \left\{{G}_{12}^{\left(1\right)} , {G}_{12}^{\left(2\right)}\right\} , \text{where} {G}_{12}^{\left(k\right)} = \left\{{s}_{12}^{\left(k\right)} \left({i}_{k}\right) : {i}_{k} = 0 , 1 , … , {l}_{k} - 1\right\} ,$$
for k = 1,2, and
$${s}_{12}^{\left(k\right)} \left({i}_{k}\right)$$
corresponds to iₖ-th SRS resource in the k-th group.

In one example, for a UE equipped with a total of N antenna ports, G₁ includes k₁ SRS resources each with N₁ SRS ports, G₃ includes k₃ SRS resources each with N SRS ports, and G₁₂ includes k₁₂ pairs of SRS resources, each with N₁ SRS ports. The UE can be indicated with (e.g., via SRI or new indicator) a N₁-port SRS resource from G₁ (e.g., in case of single panel selection), or a N-port SRS resource from G₃ (e.g., in case of STx2P), or a pair of N₁-port SRS resources from G₁₂ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) all four G₁, G₃, and G₁₂.

In one example, a UE is configured with three SRS resource sets comprising/including or (being associated with) each of the three G₁, G₃, and G₁₂, i.e., a first SRS resource set comprises/includes (or being associated with) G₁, a second SRS resource set comprises/includes (or being associated with) G₃, and a third SRS resource set comprises/includes (or being associated with) G₁₂.

In one example, a UE is configured with two SRS resource sets comprising/including or (being associated with) G₁, G₃, and G₁₂ .
In one example, a first SRS resource set comprises/includes (or being associated with) G₁ and G₃, and a second SRS resource set comprises/includes (or being associated with) G₁₂ .
In one example, a first SRS resource set comprises/includes (or being associated with) G₁ and G₁₂, and a second SRS resource set comprises/includes (or being associated with) G₃.
In one example, a first SRS resource set comprises/includes (or being associated with) G₃ and G₁₂, and a second SRS resource set comprises/includes (or being associated with) G₁.

The UE can be configured with a reporting (e.g., beam or CSI reporting via higher layer CSI-ReportConfig), wherein the reporting includes an information about one or multiple of G₁, G₃, and G₁₂. For instance, the UE can report the information about G₁ when the UE reports a single panel selection (e.g., for UL), and the UE can report the information about G₃ or G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₃ or a pair of SRS resources from G₁₂. This indication can be via SRI taking a value from 0,1, ..., k₁ + k₃ + k₁₂ - 1. Or, this indication can be via two indicators, a first indicator indicating one of G₁, G₃, and G₁₂, and a second indicator indicating a SRS resource or a pair of SRS resources from the group indicated via the first indicator.
In one example, the UE is indicated with a SRS resource (index i) from G₁ or G₃, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ + k₃ - 1} and j ∈ {0,1, ..., k₁₂ - 1}.
In one example, the UE is indicated with a SRS resource (index i ∈ {0,1, ..., k₁ - 1}) from G₁, a SRS resource (index k ∈ {0,1, ..., k₃ -1}) from G₃, and a pair of SRS resources (index j ∈ {0,1, ..., k₁₂ -1}) from G₁₂. This indication can be via a joint SRI indicating (i,k,j) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k,i).

In one example, the UE can be configured or indicated with
sTRP scheme 1: SRS resource(s) from G₁ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
sTRP scheme 3: SRS resource(s) from G₃ for an UL transmission using N ports (e.g., 1 PUSCH transmission to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁, G₃, and G₁₂, wherein
G₁ can be used/configured for a single panel (out of multiple panels) selection based UL transmission (e.g., 1 PUSCH transmission from 1 panel towards 1 TRP), and
G₁₂ or G₃ can be used/configured for STx2P based UL transmission. In one example, G₃ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with pair of SRS resources for the UL transmission based on G₁₂, then the UL transmission is for mTRP (e.g., 2 PUSCHs). In this case, the pair of SRS resources can be indicated via two SRI (e.g., SRI and second SRI fields in UL-DCI format 0_1 or 0_2).

In one example, the UE is configured with SRS resource(s) for the UL transmission based on G₁, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁ and G₂, where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group, and
G₂ comprises a second SRS-Info, which corresponds to a second group of SRS resources G₂ = {s₂(i₂): i₁ = 0,1, ..., k₂ - 1} where s₂(i₂) corresponds to i₂-th SRS resource in the second group.

In one example, G₁₂ comprises a group of SRS resource pairs G₁₂ = {(s₁(i₁₂), s₂(i₁₂)): i₁₂ = 0,1, ..., k₁₂ - 1} where s₁(i₁₂) is a SRS resource from G₁ and s₂(i₁₂) is a SRS resource from G₂. In one example, k₁₂ = k₁k₂.

In one example, for a UE equipped with a total of N antenna ports, G₁ includes k₁ SRS resources each with N₁ SRS ports, G₂ includes k₂ SRS resources each with N₁ SRS ports, and G₁₂ includes k₁₂ pairs of SRS resources, each with N₁ SRS ports. The UE can be indicated with (e.g., via SRI or new indicator) a N₁-port SRS resource from G_{⅟}G₂ (e.g., in case of single panel selection) or a pair of N₁-port SRS resources from G₁₂ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) G₁ and G₂.

In one example, a UE is configured with two SRS resource sets comprising/including or (being associated with) each of the G₁ and G₂, i.e., a first SRS resource set comprises/includes (or being associated with) G₁, a second SRS resource set comprises/includes (or being associated with) G₂.

The UE can be configured with a reporting (e.g., beam or CSI reporting via higher layer CSI-ReportConfig), wherein the reporting includes an information about one or multiple of G₁, G₂, and G₁₂. For instance, the UE can report the information about G₁ or G₂ when the UE reports a single panel selection (e.g., for UL), and the UE can report the information about G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₂ or a pair of SRS resources from G₁₂. This indication can be via SRI taking a value from 0,1, ..., k₁ + k₂ + k₁₂ - 1. Or, this indication can be via two indicators, a first indicator indicating one of G₁, G₂, and G₁₂, and a second indicator indicating a SRS resource (if the first indicator indicates one of G₁ and G₂) or a pair SRS resources (if the first indicator indicates G₁₂).
In one example, the UE is indicated with a SRS resource (index i) from G₁ or G₂, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ + k₂ - 1} and j ∈ {0,1, ..., k₁₂ - 1}.
In one example, the UE is indicated with a SRS resource (index i ∈ {0,1, ..., k₁ - 1}) from G₁, a SRS resource (index k ∈ {0,1, ..., k₂ -1}) from G₂, and a pair of SRS resources (index j ∈ {0,1, ..., k₁₂ -1}) from G₁₂. This indication can be via a joint SRI indicating (i,k,j) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k,i).

In one example, the UE can be configured or indicated with
sTRP scheme 1: SRS resource(s) from G₁ or G₂ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) transmissions can be dynamic (e.g., via UL-DCI format 0_1 or 0_2) or MAC CE or semi-static (e.g., via higher layer).

In one embodiment, a UE is configured with G₁ and G₃, where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group, and
G₃ comprises a third SRS-Info, which corresponds to a third group of SRS resources G₃ = {s₃(i₃): i₃ = 0,1, ..., k₃ - 1} where s₃(i₃) corresponds to i₃-th SRS resource in the third group.

In one example, for a UE equipped with a total of N antenna ports, G₁ includes k₁ SRS resources each with N₁ SRS ports, G₃ includes k₃ SRS resources each with N SRS ports. The UE can be indicated with (e.g., via SRI or new indicator) a N₁-port SRS resource from G₁ (e.g., in case of single panel selection), or a N-port SRS resource from G₃ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) all four G₁ and G₃.

In one example, a UE is configured with two SRS resource sets comprising/including or (being associated with) each of the two G₁ and G₃, i.e., a first SRS resource set comprises/includes (or being associated with) G₁, a second SRS resource set comprises/includes (or being associated with) G₃.

The UE can be configured with a reporting (e.g., beam or CSI reporting via higher layer CSI-ReportConfig), wherein the reporting includes an information about one or multiple of G₁ and G₃. For instance, the UE can report the information about G₁ when the UE reports a single panel selection (e.g., for UL), and the UE can report the information about G₃ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₃. This indication can be via SRI taking a value from 0,1, ..., k₁ + k₃ - 1. Or, this indication can be via two indicators, a first indicator indicating one of G₁, G₃, and a second indicator indicating a SRS resource from the group indicated via the first indicator.
In one example, the UE is indicated with a SRS resource (index i) from G₁ and a SRS resource (index j) from G₃. This indication can be via a joint SRI indicating (i,j) or via two separate SRIs, SRI1 indicating i and SRI2 indicating j, where i ∈ {0,1, ..., k₁ - 1} and j ∈ {0,1, ..., k₃ - 1}.

In one example, the UE can be configured or indicated with
sTRP scheme 1: SRS resource(s) from G₁ for an UL transmission to a single TRP (e.g., 1 PUSCH transmitted to 1 TRP using 1 panel), or
sTRP scheme 3: SRS resource(s) from G₃ for an UL transmission using N ports (e.g., 1 PUSCH transmission to 1 TRP using 2 panels).

This switching between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁ and G₃, wherein
G₁ can be used/configured for a single panel (out of multiple panels) selection based UL transmission (e.g., 1 PUSCH transmission from 1 panel towards 1 TRP), and
G₃ can be used/configured for STx2P based UL transmission. In one example, G₃ is used/configured for STx2P for sTRP (e.g., 1 PUSCH transmission from 2 panels towards 1 TRP). In one example, G₃ is used/configured for STx2P for mTRP (e.g., 2 PUSCHs transmitted from 2 panels towards 2 TRPs).

In one example, the UE is configured with SRS resource(s) for the UL transmission based on G₁, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁ and G₁₂, where
G₁ comprises a first SRS-Info, which corresponds to a first group of SRS resources G₁ = {s₁(i₁): i₁ = 0,1, ..., k₁ - 1} where s₁(i₁) corresponds to i₁-th SRS resource in the first group, and
G₁,₂ comprises a pair of (or two) SRS-Infos, which corresponds to a group of SRS resource pairs
$$\begin{matrix}{G}_{12} = \left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} , \\ \text{where} {s}_{12}^{\left(1\right)} \left({i}_{12}\right) \text{and} {s}_{12}^{\left(2\right)} \left({i}_{12}\right)\end{matrix}$$
correspond to 1^{st} and 2^{nd} SRS resource of the i₁₂-th SRS resource pair. Or, G₁,₂ corresponds to a pair of groups
$${G}_{12} = \left\{{G}_{12}^{\left(1\right)} , {G}_{12}^{\left(2\right)}\right\} , \text{where} {G}_{12}^{\left(k\right)} = \left\{{s}_{12}^{\left(k\right)} \left({i}_{k}\right) : {i}_{k} = 0 , 1 , \text{} … , {l}_{k} - 1\right\} ,$$
for k = 1,2, and
$${s}_{12}^{\left(k\right)} \left({i}_{k}\right)$$
corresponds to iₖ-th SRS resource in the k-th group.

In one example, for a UE equipped with a total of N antenna ports, G₁ includes k₁ SRS resources each with N₁ SRS ports, and G₁₂ includes k₁₂ pairs of SRS resources, each with N₁ SRS ports. The UE can be indicated with (e.g., via SRI or new indicator) a N₁-port SRS resource from G₁ (e.g., in case of single panel selection), or a pair of N₁-port SRS resources from G₁₂ (e.g., in case of STx2P). Here, N > N₁. In one example, (N, N₁) = (8,4), (8,2), (8,1), (4,2), (4,1), or (2,1).

In one example, a UE is configured with a SRS resource set comprising/including or (being associated with) all four G₁ and G₁₂.

In one example, a UE is configured with two SRS resource sets comprising/including or (being associated with) each of the two G₁ and G₁₂, i.e., a first SRS resource set comprises/includes (or being associated with) G₁, a second SRS resource set comprises/includes (or being associated with) G₁₂.

The UE can be configured with a reporting (e.g., beam or CSI reporting via higher layer CSI-ReportConfig), wherein the reporting includes an information about one or multiple of G₁ and G₁₂. For instance, the UE can report the information about G₁ when the UE reports a single panel selection (e.g., for UL), and the UE can report the information about G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or a pair of SRS resources from G₁₂. This indication can be via SRI taking a value from 0,1, ..., k₁ + k₁₂ - 1. Or, this indication can be via two indicators, a first indicator indicating one of G₁ and G₁₂, and a second indicator indicating a SRS resource or a pair of SRS resources from the group indicated via the first indicator.
In one example, the UE is indicated with a SRS resource (index i) from G₁, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ - 1} and j ∈ {0,1, ..., k₁₂ - 1}.

In one example, the UE can be configured or indicated with
sTRP scheme 1: SRS resource(s) from G₁ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).

This switching between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁and G₁₂, wherein
G₁ can be used/configured for a single panel (out of multiple panels) selection based UL transmission (e.g., 1 PUSCH transmission from 1 panel towards 1 TRP), and
G₁₂ can be used/configured for STx2P based UL transmission. In one example, G₁₂ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with pair of SRS resources for the UL transmission based on G₁₂, then the UL transmission is for mTRP (e.g., 2 PUSCHs). In this case, the pair of SRS resources can be indicated via two SRI (e.g., SRI and second SRI fields in UL-DCI format 0_1 or 0_2).

In one example, the UE is configured with SRS resource(s) for the UL transmission based on G₁, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₃ and G₁₂, where
G₃ comprises a third SRS-Info, which corresponds to a third group of SRS resources G₃ = {s₃(i₃):i₃ = 0,1, ..., k₃ - 1} where s₃(i₃) corresponds to i₃-th SRS resource in the third group, and
G_{1,2} comprises a pair of (or two) SRS-Infos, which corresponds to a group of SRS resource pairs
$${G}_{12} = \left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} ,$$
where
$${s}_{12}^{\left(1\right)} \left({i}_{12}\right)$$
and
$${s}_{12}^{\left(2\right)} \left({i}_{12}\right)$$
correspond to 1^{st} and 2^{nd} SRS resource of the i₁₂-th SRS resource pair. Or, G_{1,2} corresponds to a pair of groups
$${G}_{12} = \left\{{G}_{12}^{\left(1\right)} , {G}_{12}^{\left(2\right)}\right\} , \text{where} {G}_{12}^{\left(k\right)} = \left\{{s}_{12}^{\left(k\right)} \left({i}_{k}\right) : {i}_{k} = 0 , 1 , … , {l}_{k} - 1\right\} ,$$
for k = 1,2, and
$${s}_{12}^{\left(k\right)} \left({i}_{k}\right)$$
corresponds to iₖ-th SRS resource in the k-th group.

In one example, G₁ can comprise k₁ SRS resources which corresponds to the first SRS resources in the pairs of SRS resources in G₁₂, or G₁ can comprise k₁ SRS resources which corresponds to the second SRS resources in the pairs of SRS resources in G₁₂, or G₁ can comprise k₁ SRS resources which corresponds to the first or the second SRS resources in the pairs of SRS resources in G₁₂. In one example, G₁ and G₂ can comprise k₁ and k₂ SRS resources which correspond to the first and the second SRS resources, respectively, in the pairs of SRS resources in G₁₂.

In one example, for a UE equipped with a total of N antenna ports, G₃ includes k₃ SRS resources each with N SRS ports, and G₁₂ includes k₁₂ pairs of SRS resources, each with N₁ SRS ports. The UE can be indicated with (e.g., via SRI or new indicator) a N₁-port SRS resource from G₁ or G₂ (e.g., in case of SP transmission), or a N-port SRS resource from G₃ (e.g., in case of STx2P), or a pair of N₁-port SRS resources from G₁₂ (e.g., in case of STx2P). Here, N > N₁. In one example, (N,N₁) = (8,4), (8,2), (8,1), (4,2), (4,1), or (2,1).

In one example, a UE is configured with a SRS resource set comprising/including or (being associated with) all four G₃ and G₁₂.

In one example, a UE is configured with two SRS resource sets comprising/including or (being associated with) each of the two G₃ and G₁₂, i.e., a first SRS resource set comprises/includes (or being associated with) G₃ and a second SRS resource set comprises/includes (or being associated with) G₁₂.

The UE can be configured with a reporting (e.g., beam or CSI reporting via higher layer CSI-ReportConfig), wherein the reporting includes an information about one or multiple of G₃, and G₁₂. For instance, the UE can report the information about G₁ and/or G₂ when the UE reports a single panel selection (e.g., for UL), and the UE can report the information about G₃ or G₁₂ when the UE reports multiple panels (e.g., STx2P for UL).

At least one of the following examples is used/configured regarding the selection/indication of SRS resource(s), e.g., via SRI or a new indicator (in DCI, e.g., UL-DCI format 0_1 or 0_2) or via higher layer.
In one example, the UE is indicated with a SRS resource from G₁ or G₃ or a pair of SRS resources from G₁₂. This indication can be via SRI taking a value from 0,1, ..., k₁ + k₃ + k₁₂ - 1. Or, this indication can be via two indicators, a first indicator indicating one of G₁, G₃, and G₁₂, and a second indicator indicating a SRS resource or a pair of SRS resources from the group indicated via the first indicator.
In one example, the UE is indicated with a SRS resource (index i) from G₁ or G₃, and a pair of SRS resources (index j) from G₁₂. This indication can be via a joint SRI indicating (i,j) or via two separate SRIs, SRI1 indicating i and SRI2 indicating j, where i ∈ {0,1, ..., k₁ + k₃ - 1} and j ∈ {0,1, ..., k₁₂ - 1}.
In one example, the UE is indicated with a SRS resource (index i ∈ {0,1, ..., k₁ - 1}) from G₁, a SRS resource (index k ∈ {0,1, ..., k₃ - 1}) from G₃, and a pair of SRS resources (index j ∈ {0,1, ..., k₁₂ -1}) from G₁₂. This indication can be via a joint SRI indicating (i, k,j) or via three separate SRIs, SRI1 indicating i, SRI2 indicating k, and SRI3 indicating j. Or, this indication can be via a two SRIs.
   In one example, SRI1 indicating i, SRI2 indicating (k,j).
   In one example, SRI1 indicating k, SRI2 indicating (i,j).
   In one example, SRI1 indicating j, SRI2 indicating (k, i).

In one example, the UE can be configured or indicated with
sTRP scheme 1: SRS resource(s) from G₁ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
sTRP scheme 3: SRS resource(s) from G₃ for an UL transmission using N ports (e.g., 1 PUSCH transmission to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁, G₃, and G₁₂, wherein
G₁ can be used/configured for a single panel (out of multiple panels) selection based UL transmission (e.g., 1 PUSCH transmission from 1 panel towards 1 TRP), and
G₁₂ or G₃ can be used/configured for STx2P based UL transmission. In one example, G₃ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with pair of SRS resources for the UL transmission based on G₁₂, then the UL transmission is for mTRP (e.g., 2 PUSCHs). In this case, the pair of SRS resources can be indicated via two SRI (e.g., SRI and second SRI fields in UL-DCI format 0_1 or 0_2).

In one example, the UE is configured with SRS resource(s) for the UL transmission based on G₁, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁₂, where G_{1,2} comprises a pair of (or two) SRS-Infos, which corresponds to a group of SRS resource pairs G₁₂ =

$$\left\{\left({s}_{12}^{\left(1\right)} \left({i}_{12}\right) , {s}_{12}^{\left(2\right)} \left({i}_{12}\right)\right) : {i}_{12} = 0 , 1 , … , {k}_{12} - 1\right\} ,$$

where

$${s}_{12}^{\left(1\right)} \left({i}_{12}\right)$$

and

$${s}_{12}^{\left(2\right)} \left({i}_{12}\right)$$

correspond to 1^{st} and 2^{nd} SRS resource of the i₁₂-th SRS resource pair. Or, G_{1,2} corresponds to a pair of groups G₁₂ =

$$\left\{{G}_{12}^{\left(1\right)} , {G}_{12}^{\left(2\right)}\right\} ,$$

where

$${G}_{12}^{\left(k\right)} = \left\{{s}_{12}^{\left(k\right)} \left({i}_{k}\right) : {i}_{k} = 0 , 1 , … , {l}_{k} - 1\right\} , \text{for} k = 1 , 2 , \text{and} {s}_{12}^{\left(k\right)} \left({i}_{k}\right)$$

corresponds to iₖ-th SRS resource in the k-th group.

In one example, G₁ can comprise k₁ SRS resources which corresponds to the first SRS resources in the pairs of SRS resources in G₁₂, or G₁ can comprise k₁ SRS resources which corresponds to the second SRS resources in the pairs of SRS resources in G₁₂, or G₁ can comprise k₁ SRS resources which corresponds to the first or the second SRS resources in the pairs of SRS resources in G₁₂. In one example, G₁ and G₂ can comprise k₁ and k₂ SRS resources which correspond to the first and the second SRS resources, respectively, in the pairs of SRS resources in G₁₂.

In one example, for a UE equipped with a total of N antenna ports, G₁₂ includes k₁₂ pairs of SRS resources, each with N₁ SRS ports. The UE can be indicated with (e.g., via SRI or new indicator) a N₁-port SRS resource from G₁ or G₂ (e.g., in case of SP transmission), or a pair of N₁-port SRS resources from G₁₂ (e.g., in case of STx2P). Here, N > N₁. In one example, (N, N₁) = (8,4), (8,2), (8,1), (4,2), (4,1), or (2,1).

In one example, a UE is configured with a SRS resource set comprising/including or (being associated with) G₁₂.

The UE can be configured with a reporting (e.g., beam or CSI reporting via higher layer CSI-ReportConfig), wherein the reporting includes an information about one or multiple of G₁, G₂, and G₁₂. For instance, the UE can report the information about G₁ and/or G₂ when the UE reports a single panel selection (e.g., for UL), and the UE can report the information about G₁₂ when the UE reports multiple panels (e.g., STx2P for UL).

At least one of the following examples is used/configured regarding the SRI indication.
In one example, a single SRI is indicated which selects a pair of the SRS resources from G₁₂.
In one example, a single SRI is indicated which select either single SRS resource (from G₁ or G₂), or a pair of SRS resources from G₁₂ .
In one example, two SRIs (SRI1, SRI2) are indicated, and
   In one example, SRI1 selects a resource from G₁ and SRI2 selects a pair of SRS resources from G₁₂.
   In one example, SRI1 selects a resource from G₁ and SRI2 selects a SRS resource from G₂.
In one example, three SRIs (SRI1, SRI2) are indicated, and SRI1 selects a resource from G₁, SRI2 selects a resource from G₂, and SRI3 selects a pair of SRS resources from G₁₂.

In one example, the UE can be configured or indicated with
sTRP scheme 1: SRS resource(s) from G₁ for an UL transmission to a single TRP (e.g., 1 PUSCH transmitted to 1 TRP using 1 panel), or
sTPP scheme 2: a pair of SRS resource(s) from G₁₂ for an UL transmission to 1 TRP (e.g., 1 PUSCH transmitted to 1 TRP using 2 panels).
mTPP scheme 1: a pair of SRS resource(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between N₁-port (1 panel) and N-port (2 panels) transmissions can be dynamic (e.g., via UL-DCI format 0_1 or 0_2) or MAC CE or semi-static (e.g., via higher layer).

In one example, the UE is configured with SRS resource(s) or pair of SRS resources for the UL transmission based on G₁, G₂, and G₁₂, wherein
G₁ or G₂ can be used/configured for a single panel (out of multiple panels) selection based UL transmission (e.g., 1 PUSCH transmission from 1 panel towards 1 TRP), and
G₁₂ can be used/configured for STx2P based UL transmission. In one example, G₁₂ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with pair of SRS resources for the UL transmission based on G₁₂, then the UL transmission is for mTRP (e.g., 2 PUSCHs). In this case, the pair of SRS resources can be indicated via two SRI (e.g., SRI and second SRI fields in UL-DCI format 0_1 or 0_2).

In one example, the UE is configured with SRS resource(s) for the UL transmission based on G₁, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁, G₂, and G₁₂ where
G₁ comprises a first SRS-Info, which corresponds to a first group of SRS ports G₁ = {p₁(i₁):i₁ = 0,1, ..., n₁ - 1} where p₁(i₁) corresponds to i₁-th SRS port in the first group,
G₂ comprises a second SRS-Info, which corresponds to a second group of SRS ports G₂ = {p₂(i₂):i₁ = 0,1, ..., n₂ - 1} where p₂(i₂) corresponds to i₂-th SRS port in the second group, and
G_{1,2} comprises a pair of (or two) SRS-Infos, which corresponds to a group of SRS port pairs
$${G}_{12} = \left\{\left({p}_{12}^{\left(1\right)} \left({i}_{12}\right) , {p}_{12}^{\left(2\right)} \left({i}_{12}\right)\right) : {i}_{12} = 0 , 1 , … , {n}_{12} - 1\right\} ,$$
where
$${p}_{12}^{\left(1\right)} \left({i}_{12}\right)$$
and
$${p}_{12}^{\left(2\right)} \left({i}_{12}\right)$$
correspond to 1^{st} and 2^{nd} SRS ports of the i₁₂-th SRS port pair. Or, G_{1,2} corresponds to a pair of groups
$${G}_{12} = \left\{{G}_{12}^{\left(1\right)} , {G}_{12}^{\left(2\right)}\right\} ,$$
where
$${G}_{12}^{\left(k\right)} = \left\{{p}_{12}^{\left(k\right)} \left({i}_{k}\right) : {i}_{k} = 1 , 2 , … {l}_{k} - 1\right\} ,$$
for k = 1,2, and
$${p}_{12}^{\left(k\right)} \left({i}_{k}\right)$$
corresponds to iₖ-th SRS port in the k-th group.

In one example, for a UE equipped with a total of N antenna ports, G₁ includes n₁ SRS ports, G₂ includes n₂ SRS ports, and G₁₂ includes n₁₂ pairs of SRS ports. The UE can be indicated with (e.g., via SRI or new indicator) a group of SRS ports, i.e., G₁ or G₂ (e.g., in case of single panel selection) or a pair (or two) groups of SRS ports G₁₂ (e.g., in 2case of STx2P). Here, N > n₁,n₂. In one example, (N,n₁) or (N,n₂) = (8,4), (8,2), (8,1), (4,2), (4,1), or (2,1).

In one example, n₁₂ = n₁ + n₂. In one example, n₁ = n₂ = 2 or 1 or 4.

In one example, G₁ comprises SRS ports {0,2,...} and G₂ comprises SRS ports {1,3,...}.

In one example, G₁ comprises SRS ports {0,1,2...} and G₂ comprises SRS ports

In one example, n₁ can be different from n₂, e.g., (n₁, n₂) = (2,4) or (4,2), or (1,2) or (2,1).

In one example, n₁₂ can be different from n₁ + n₂.

In one example, the grouping information (e.g., values n₁, n₂, n₁₂, and/or SRS ports (indices) comprising G₁, G₂, and G₁₂) is fixed, or configured (e.g., via higher layer, or MAC CE, or DCI).

In one example, first and second groups G₁ and G₂ can correspond to (associated with) a same SRS resource.

In one example, first and second groups G₁ and G₂ can correspond to (associated with) same or different SRS resources.

In one example, a UE is configured with a SRS resource set (e.g., via higher layer) comprising one or multiple (e.g., 2 or 4) SRS resources such that each SRS resource is associated with the same number of SRS ports (N). Then, G₁, G₂, and G₁₂ as defined above apply to each SRS resource within the SRS resource set.

In one example, a UE is configured with one or multiple (e.g., 2) SRS resource sets (e.g., via higher layer), each set comprising one or multiple (e.g., 2 or 4) SRS resources such that each SRS resource within a set is associated with the same number of SRS ports (N). Then, G₁, G₂, and G₁₂ as defined above apply to each SRS resource within the SRS resource sets.

The UE can be configured with a reporting (e.g., beam or CSI reporting via higher layer CSI-ReportConfig), wherein the reporting includes an information about one or multiple of G₁, G₂, and G₁₂. For instance, the UE can report the information about G₁ or G₂ when the UE reports a single panel selection (e.g., for UL), and the UE can report the information about G₁₂ when the UE reports multiple panels (e.g., STx2P for UL).

At least one of the following examples is used/configured regarding the selection/indication of SRS port(s)/group(s), e.g., via SRI or a new indicator (in DCI, e.g., UL-DCI format 0_1 or 0_2) or via higher layer.
In one example, the UE is indicated with a group of SRS ports G₁ or G₂ or a pair of SRS port groups G₁₂. This indication can be joint via SRI, which can be indicated with both a SRS resource (when the UE is configured with multiple SRS resources) and one of G₁, G₂, and G₁₂ for the indicated SRS resource. Or, this indication can be separate, e.g., SRI indicating a SRS resource (when the UE is configured with multiple SRS resources), and another indicator indicating one of G₁, G₂, and G₁₂ for the indicated SRS resource.

In one example, the UE can be configured or indicated with
sTRP scheme 1: SRS port(s) from G₁ or G₂ for an UL transmission to a single TRP (e.g., 1 PUSCH transmitted to 1 TRP using 1 panel), or
sTPP scheme 2: a pair of SRS port(s) from G₁₂ for an UL transmission to 1 TRP (e.g., 1 PUSCH transmitted to 1 TRP using 2 panels).
mTPP scheme 1: a pair of SRS port(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) transmissions can be dynamic (e.g., via UL-DCI format 0_1 or 0_2) or MAC CE or semi-static (e.g., via higher layer).

In one embodiment, a UE is configured with G₁, G₂, and G₃ where
G₁ comprises a first SRS-Info, which corresponds to a first group of SRS ports G₁ = {p₁(i₁):i₁ = 0,1, ..., n₁ - 1} where p₁(i₁) corresponds to i₁-th SRS port in the first group,
G₂ comprises a second SRS-Info, which corresponds to a second group of SRS ports G₂ = {p₂(i₂):i₁ = 0,1, ..., n₂ - 1} where p₂(i₂) corresponds to i₂-th SRS port in the second group, and
G₃ comprises a third SRS-Info, which corresponds to a third group of SRS ports G₃ = {p₃(i₃):i₃ = 0,1, ..., N - 1} where p₃(i₃) corresponds to i₃-th SRS port in the third group.

In one example, for a UE equipped with a total of N antenna ports, G₁ includes n₁ SRS ports, G₂ includes n₂ SRS ports, and G₃ includes N SRS ports. The UE can be indicated with (e.g., via SRI or new indicator) a group of SRS ports, i.e., G₁ or G₂ (e.g., in case of single panel selection) or a group of SRS ports G₃ (e.g., in case of STx2P). Here, N > n₁,n₂. In one example, (N, n₁) or (N, n₂) = (8,4), (8,2), (8,1), (4,2), (4,1), or (2,1).

In one example, a UE is configured with a SRS resource set comprising/including or (being associated with) all three G₁, G₂, and G₃.

In one example, N = n₁ + n₂. In one example, n₁ = n₂ = 2 or 1 or 4.

In one example, G₁ comprises SRS ports {0,2,...} and G₂ comprises SRS ports {1,3,...}.

In one example, G₁ comprises SRS ports {0,1,2...} and G₂ comprises SRS ports

$$\left\{\frac{N}{2} , \frac{N}{2} + 1 , ... N\right\} .$$

In one example, n₁ can be different from n₂, e.g., (n₁, n₂) = (2,4) or (4,2), or (1,2) or (2,1).

In one example, N can be different from n₁ + n₂.

In one example, the grouping information (e.g., values n₁, n₂, N, and/or SRS ports (indices) comprising G₁, G₂, and G₃) is fixed, or configured (e.g., via higher layer, or MAC CE, or DCI).

In one example, first and second groups G₁ and G₂ can correspond to (associated with) a same SRS resource.

In one example, first and second groups G₁ and G₂ can correspond to (associated with) same or different SRS resources.

In one example, a UE is configured with a SRS resource set (e.g., via higher layer) comprising one or multiple (e.g., 2 or 4) SRS resources such that each SRS resource is associated with the same number of SRS ports (N). Then, G₁, G₂, and G₃ as defined above apply to each SRS resource within the SRS resource set.

In one example, a UE is configured with one or multiple (e.g., 2) SRS resource sets (e.g., via higher layer), each set comprising one or multiple (e.g., 2 or 4) SRS resources such that each SRS resource within a set is associated with the same number of SRS ports (N). Then, G₁, G₂, and G₃ as defined above apply to each SRS resource within the SRS resource sets.

The UE can be configured with a reporting (e.g., beam or CSI reporting via higher layer CSI-ReportConfig), wherein the reporting includes an information about one or multiple of G₁, G₂, and G₃. For instance, the UE can report the information about G₁ or G₂ when the UE reports a single panel selection (e.g., for UL), and the UE can report the information about G₃ when the UE reports multiple panels (e.g., STx2P for UL).

At least one of the following examples is used/configured regarding the selection/indication of SRS port(s)/group(s), e.g., via SRI or a new indicator (in DCI, e.g., UL-DCI format 0_1 or 0_2) or via higher layer.
In one example, the UE is indicated with a group of SRS ports G₁ or G₂ or G₃. This indication can be joint via SRI, which can be indicated with both a SRS resource (when the UE is configured with multiple SRS resources) and one of G₁, G₂, and G₃ for the indicated SRS resource. Or, this indication can be separate, e.g., SRI indicating a SRS resource (when the UE is configured with multiple SRS resources), and another indicator indicating one of G₁, G₂, and G₃ for the indicated SRS resource.

In one example, the UE can be configured or indicated with
sTRP scheme 1: SRS resource(s) from G₁ or G₂ for an UL transmission using n₁ or n₂ ports (e.g., 1 PUSCH transmitted to 1 TRP using 1 panel), or
sTRP scheme 3: SRS resource(s) from G₃ for an UL transmission using N ports (e.g., 1 PUSCH transmission to 1 TRP using 2 panels).

This switching between nᵢ-port (1 panel) and N-port (2 panels) UL transmissions can be dynamic (e.g., via UL-DCI format 0_1 or 0_2) or MAC CE or semi-static (e.g., via higher layer). In one example, this nᵢ-port or N-port UL transmission can be for a single PUSCH (directed towards a single TRP).

In one embodiment, a UE is configured with G₁, G₂, G₃, and G₁₂ where
G₁ comprises a first SRS-Info, which corresponds to a first group of SRS ports G₁ = {p₁(i₁):i₁ = 0,1, ..., n₁ - 1} where p₁(i₁) corresponds to i₁-th SRS port in the first group,
G₂ comprises a second SRS-Info, which corresponds to a second group of SRS ports G₂ = {p₂(i₂):i₁ = 0,1, ..., n₂ - 1} where p₂(i₂) corresponds to i₂-th SRS port in the second group, and
G₃ comprises a third SRS-Info, which corresponds to a third group of SRS ports G₃ = {p₃(i₃):i₃ = 0,1, ..., N - 1} where p₃(i₃) corresponds to i₃-th SRS port in the third group.
G_{1,2} comprises a pair of (or two) SRS-Infos, which corresponds to a group of SRS port pairs
$${G}_{12} = \left\{\left({p}_{12}^{\left(1\right)} , \left({i}_{12}\right) , {p}_{12}^{\left(2\right)} \left({i}_{12}\right)\right) : {i}_{12} = 0 , 1 , … , {n}_{12} - 1\right\} ,$$
where
$${p}_{12}^{\left(1\right)} \left({i}_{12}\right)$$
and
$${p}_{12}^{\left(2\right)} \left({i}_{12}\right)$$
correspond to 1^{st} and 2^{nd} SRS ports of the i₁₂-th SRS port pair. Or, G_{1,2} corresponds to a pair of groups
$${G}_{12} = \left\{{G}_{12}^{\left(1\right)} , {G}_{12}^{\left(2\right)}\right\} , \text{where} {G}_{12}^{\left(k\right)} = \left\{{p}_{12}^{\left(k\right)} \left({i}_{k}\right) : {i}_{k} = 0 , 1 , … , {l}_{k} - 1\right\} ,$$
for k = 1,2, and
$${p}_{12}^{\left(k\right)} \left({i}_{k}\right)$$
corresponds to iₖ-th SRS port in the k-th group.

In one example, for a UE equipped with a total of N antenna ports, G₁ includes n₁ SRS ports, G₂ includes n₂ SRS ports, G₃ includes N SRS ports, and G₁₂ includes n₁₂ pairs of SRS ports. The UE can be indicated with (e.g., via SRI or new indicator) a group of SRS ports, i.e., G₁ or G₂ (e.g., in case of single panel selection) or a group of SRS ports G₃ (e.g., in case of STx2P) or a pair (or two) groups of SRS ports G₁₂ (e.g., in case of STx2P). Here, N > n₁,n₂. In one example, (N, n₁) or (N, n₂) = (8,4), (8,2), (8,1), (4,2), (4,1), or (2,1).

In one example, n₁₂ = n₁ + n₂. In one example, N = n₁ + n₂. In one example, n₁ = n₂ = 2 or 1 or 4.

In one example, G₁ comprises SRS ports {0,2,...} and G₂ comprises SRS ports {1,3,...}.

In one example, G₁ comprises SRS ports {0,1,2...} and G₂ comprises SRS ports

$$\left\{\frac{N}{2} , \frac{N}{2} + 1 , ... N\right\} .$$

In one example, n₁ can be different from n₂, e.g., (n₁,n₂) = (2,4) or (4,2), or (1,2) or (2,1).

In one example, n₁₂ can be different from n₁ + n₂. In one example, N can be different from n₁ + n₂.

In one example, the grouping information (e.g., values n₁, n₂, n₁₂, N, and/or SRS ports (indices) comprising G₁, G₂, G₃, and G₁₂) is fixed, or configured (e.g., via higher layer, or MAC CE, or DCI).

In one example, first and second groups G₁ and G₂ can correspond to (associated with) a same SRS resource.

In one example, first and second groups G₁ and G₂ can correspond to (associated with) same or different SRS resources.

In one example, a UE is configured with a SRS resource set (e.g., via higher layer) comprising one or multiple (e.g., 2 or 4) SRS resources such that each SRS resource is associated with the same number of SRS ports (N). Then, G₁, G₂, G₃, and G₁₂ as defined above apply to each SRS resource within the SRS resource set.

In one example, a UE is configured with one or multiple (e.g., 2) SRS resource sets (e.g., via higher layer), each set comprising one or multiple (e.g., 2 or 4) SRS resources such that each SRS resource within a set is associated with the same number of SRS ports (N). Then, G₁, G₂, G₃, and G₁₂ as defined above apply to each SRS resource within the SRS resource sets.

The UE can be configured with a reporting (e.g., beam or CSI reporting via higher layer CSI-ReportConfig), wherein the reporting includes an information about one or multiple of G₁, G₂, G₃, and G₁₂. For instance, the UE can report the information about G₁ or G₂ when the UE reports a single panel selection (e.g., for UL), and the UE can report the information about G₁₂ or G₃ when the UE reports multiple panels (e.g., STx2P for UL).

At least one of the following examples is used/configured regarding the selection/indication of SRS port(s)/group(s), e.g., via SRI or a new indicator (in DCI, e.g., UL-DCI format 0_1 or 0_2) or via higher layer.
In one example, the UE is indicated with a group of SRS ports G₁ or G₂ or G₃ or a pair of SRS port groups G₁₂. This indication can be joint via SRI, which can be indicated with both a SRS resource (when the UE is configured with multiple SRS resources) and one of G₁, G₂, G₃ and G₁₂ for the indicated SRS resource. Or, this indication can be separate, e.g., SRI indicating a SRS resource (when the UE is configured with multiple SRS resources), and another indicator indicating one of G₁, G₂, G₃, and G₁₂ for the indicated SRS resource.

In one example, the UE can be configured or indicated with
sTRP scheme 1: SRS port(s) from G₁ or G₂ for an UL transmission to a single TRP (e.g., 1 PUSCH transmitted to 1 TRP using 1 panel), or
sTPP scheme 2: a pair of SRS port(s) from G₁₂ for an UL transmission to 1 TRP (e.g., 1 PUSCH transmitted to 1 TRP using 2 panels).
sTRP scheme 3: SRS port(s) from G₃ for an UL transmission using N ports (e.g., 1 PUSCH transmission to 1 TRP using 2 panels).
mTPP scheme 1: a pair of SRS port(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between nᵢ-port (1 panel) and N-port (2 panels) transmissions can be dynamic (e.g., via UL-DCI format 0_1 or 0_2) or MAC CE or semi-static (e.g., via higher layer).

In one example, the UE is configured with group of SRS port(s) or SRS port pairs for the UL transmission based on G₁, G₂, G₃, and G₁₂, wherein
G₁ or G₂ can be used/configured for a single panel (out of multiple panels) selection based UL transmission (e.g., 1 PUSCH transmission from 1 panel towards 1 TRP), and
G₁₂ or G₃ can be used/configured for STx2P based UL transmission. In one example, G₃ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with a group of SRS port pairs for the UL transmission based on G₁₂, then the UL transmission is for mTRP (e.g., 2 PUSCHs). In this case, the group of SRS port pairs can be indicated via two SRI (e.g., SRI and second SRI fields in UL-DCI format 0_1 or 0_2).

In one example, the UE is configured with a group of SRS port(s) for the UL transmission based on G₁, G₂, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁, G₃, and G₁₂, which are defined as described herein.

In one example, for a UE equipped with a total of N antenna ports, G₁ includes n₁ SRS ports, G₃ includes N SRS ports, and G₁₂ includes n₁₂ pairs of SRS ports. The UE can be indicated with (e.g., via SRI or new indicator) a group of SRS ports, i.e., G₁ (e.g., in case of single panel selection) or a group of SRS ports G₃ (e.g., in case of STx2P) or a pair (or two) groups of SRS ports G₁₂ (e.g., in case of STx2P). Here, N > n₁,n₂. In one example, (N, n₁) = (8,4), (8,2), (8,1), (4,2), (4,1), or (2,1).

In one example, n₁₂ = 2n₁. In one example, N = 2n₁. In one example, n₁ = 2 or 1 or 4.

In one example, G₁ comprises SRS ports {0,2,...} or {1,3,...}.

In one example, G₁ comprises SRS ports {0,1,2...} or

$$\left\{\frac{N}{2} , \frac{N}{2} + 1 , … N\right\} .$$

In one example, n₁₂ can be different from 2n₁. In one example, N can be different from 2n₁.

In one example, the grouping information (e.g., values n₁, n₁₂, N, and/or SRS ports (indices) comprising G₁, G₃, and G₁₂) is fixed, or configured (e.g., via higher layer, or MAC CE, or DCI).

In one example, three groups can correspond to (associated with) a same SRS resource.

In one example, three groups can correspond to (associated with) same or different SRS resources.

In one example, a UE is configured with a SRS resource set (e.g., via higher layer) comprising one or multiple (e.g., 2 or 4) SRS resources such that each SRS resource is associated with the same number of SRS ports (N). Then, G₁, G₃, and G₁₂ as defined above apply to each SRS resource within the SRS resource set.

In one example, a UE is configured with one or multiple (e.g., 2) SRS resource sets (e.g., via higher layer), each set comprising one or multiple (e.g., 2 or 4) SRS resources such that each SRS resource within a set is associated with the same number of SRS ports (N). Then, G₁, G₃, and G₁₂ as defined above apply to each SRS resource within the SRS resource sets.

The UE can be configured with a reporting (e.g., beam or CSI reporting via higher layer CSI-ReportConfig), wherein the reporting includes an information about one or multiple of G₁, G₃, and G₁₂. For instance, the UE can report the information about G₁ when the UE reports a single panel selection (e.g., for UL), and the UE can report the information about G₁₂ or G₃ when the UE reports multiple panels (e.g., STx2P for UL).

At least one of the following examples is used/configured regarding the selection/indication of SRS port(s)/group(s), e.g., via SRI or a new indicator (in DCI, e.g., UL-DCI format 0_1 or 0_2) or via higher layer.
In one example, the UE is indicated with a group of SRS ports G₁ or G₃ or a pair of SRS port groups G₁₂. This indication can be joint via SRI, which can be indicated with both a SRS resource (when the UE is configured with multiple SRS resources) and one of G₁, G₃ and G₁₂ for the indicated SRS resource. Or, this indication can be separate, e.g., SRI indicating a SRS resource (when the UE is configured with multiple SRS resources), and another indicator indicating one of G₁, G₃, and G₁₂ for the indicated SRS resource.

In one example, the UE can be configured or indicated with
sTRP scheme 1: SRS port(s) from G₁ for an UL transmission to a single TRP (e.g., 1 PUSCH transmitted to 1 TRP using 1 panel), or
sTPP scheme 2: a pair of SRS port(s) from G₁₂ for an UL transmission to 1 TRP (e.g., 1 PUSCH transmitted to 1 TRP using 2 panels).
sTRP scheme 3: SRS port(s) from G₃ for an UL transmission using N ports (e.g., 1 PUSCH transmission to 1 TRP using 2 panels).
mTPP scheme 1: a pair of SRS port(s) from G₁₂ for an UL transmission to 2 TRPs (e.g., 2 PUSCH transmitted to 2 TRPs using 2 panels).

This switching between 1 PUSCH and 2 PUSCH (or between sTRP and mTRP schemes) or between n₁-port (1 panel) and N-port (2 panels) transmissions can be dynamic (e.g., via UL-DCI format 0_1 or 0_2) or MAC CE or semi-static (e.g., via higher layer).

In one example, the UE is configured with group of SRS port(s) or SRS port pairs for the UL transmission based on G₁, G₃, and G₁₂, wherein
G₁ can be used/configured for a single panel (out of multiple panels) selection based UL transmission (e.g., 1 PUSCH transmission from 1 panel towards 1 TRP), and
G₁₂ or G₃ can be used/configured for STx2P based UL transmission. In one example, G₃ is used/configured for STx2P for sTRP (e.g., 1 PUSCH transmission from 2 panels towards 1 TRP). In one example, G₁₂ is used/configured for STx2P for mTRP (e.g., 2 PUSCHs transmitted from 2 panels towards 2 TRPs).

In one example, the UE is configured with a group of SRS port pairs for the UL transmission based on G₁₂, then the UL transmission is for mTRP (e.g., 2 PUSCHs). In this case, the group of SRS port pairs can be indicated via two SRI (e.g., SRI and second SRI fields in UL-DCI format 0_1 or 0_2).

In one example, the UE is configured with a group of SRS port(s) for the UL transmission based on G₁, or G₃, then the UL transmission is for sTRP (e.g., 1 PUSCH). In this case, the SRS resource(s) can be indicated via one SRI (e.g., SRI field in UL-DCI format 0_1 or 0_2).

In one example, the UE is indicated with a dynamic UL transmission scheme to select between sTRP vs mTRP and/or 1 PUSCH vs 2 PUSCHs and/or 1 panel vs 2 panel for UL transmission.

In one embodiment, a UE is configured with G₁ and G₂, which are defined herein.

In one example, G₁₂ comprises a group of SRS port pairs G₁₂ = {(p₁(i₁₂),p₂(i₁₂)):i₁₂ = 0,1, ..., n₁₂ - 1} where p₁(i₁₂) is a SRS port from G₁ and p₂(i₁₂) is a SRS port from G₂. In one example,

$${n}_{12} = \frac{N}{{n}_{1}} .$$

In one example, G₁₂ = {G₁, G₂}.

The rest of the details are the same as described herein with G₁, G₂, and G_{1,2} as defined here.

In one embodiment, a UE is configured with G₁ and G₃, which are defined as described herein. The rest of the details are the same as described herein with G₁ and G₃ as defined here.

In one embodiment, a UE is configured with G₁ and G₁₂, which are defined as described herein. The rest of the details are the same as described herein with G₁ and G_{1,2} as defined here.

In one embodiment, a UE is configured with G₃ and G₁₂, which are defined as described herein. The rest of the details are the same as described herein with G₃ and G_{1,2} as defined here.

In one embodiment, a UE is configured with G₁₂, which is defined as described herein. The rest of the details are the same as described herein with G_{1,2} as defined here.

In one embodiment, a UE is configured with 1 UL (e.g., PUSCH) or 2 UL (e.g., PUSCHs) transmissions based on a configuration of at least one or multiple of G₁, G₂, G₃, and G₁₂, as described herein.

For the case of 1 UL (e.g., PUSCH) transmission, e.g., to 1 TRP, the UE is configured with the same set of G₁, G₂, G₃, and/or G₁₂.

For the case of 2 UL (e.g., PUSCHs) transmissions, e.g., to 2 TRPs, the UE is configured with G₁, G₂, G₃, and/or G₁₂ according to at least one of the following examples.
In one example, the UE is configured with the same set of G₁, G₂, G₃, and/or G₁₂ for both UL transmissions, i.e., the group(s) is (are) configured common for both UL transmissions. In one example, such an UL transmission can be configured for the case when a single DCI grants 2 UL transmissions.
   In one example, G₁ can be used for UL transmission to TRP1, G₂ can be used for UL transmission to TRP2, G₃ can be used STx2P to TRP1 or TRP2 (e.g., panels 1 and 2 to TRP1/TRP2), and G₁₂ can be used STx2P to TRP1 and TRP2 (e.g., panel 1 to TRP1 and panel 2 to TRP2).
In one example, the UE is configured with the two different sets of G₁, G₂, G₃, and/or G₁₂ for both UL transmissions, i.e., the group(s) is (are) configured separately for each UL transmission. In one example, such an UL transmission can be configured for the case when multiple (separate) DCIs grant 2 UL transmissions.
In one example, the UE is configured with the same (one common) set of S1 for both UL transmissions, and two different sets of S2 for two UL transmissions.
   In one example, S1 includes one or multiple of G₁, G₂, G₃, and S2 includes G₁₂.
   In one example, S1 includes one or multiple of G₁, G₂, G₁₂, and S2 includes G₃.
   In one example, S1 includes one or multiple of G₁, G₃, and S2 includes G₁₂.
   In one example, S1 includes one or multiple of G₁, G₁₂, and S2 includes G₃.
   In one example, S1 includes one or multiple of G₁, G₂, and S2 includes one or multiple of G₃ and G₁₂.
   In one example, S1 includes G₁ and S2 includes one or multiple of G₃ and G₁₂.

The present disclose provides examples of groups for the case of two antenna panels at the UE. The embodiments of this disclosure, however, are general, and can easily be extended to more than 2 antenna panels by one skilled-in-the-art.

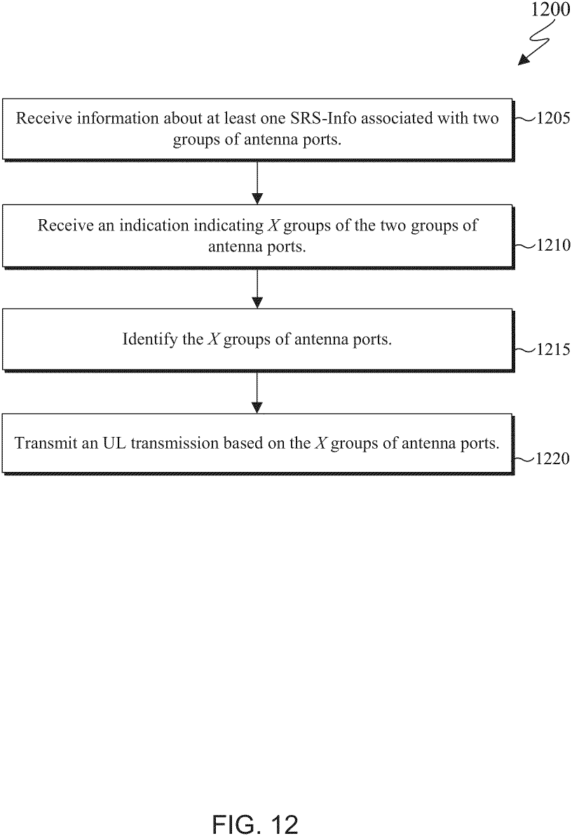

FIG. 12 illustrates a flowchart for a method 1200 for utilizing an SRS configuration according to embodiments of the present disclosure. For example, the method 1200 may be performed by The embodiment of the method 1200 illustrated in FIG. 12 is for illustration only. FIG. 12 does not limit the scope of this disclosure to any particular implementation.

The method begins with the UE receiving information about at least one SRS-Info associated with two groups of antenna ports (1205). For example, in 1205, the at least one SRS-Info corresponds to a group of SRS resources or ports.

In various embodiments, the at least one SRS-Info includes one or more of G₁, G₂, G₃, and G_{1,2}, where: G₁ is a first SRS-Info that is associated with a first group of SRS resources or ports, G₂ is a second SRS-Info that is associated with a second group of SRS resources or ports, G₃ is a third SRS-Info that is associated with both the first and the second groups of SRS resources or ports, and G_{1,2} is a pair of SRS-Info, one of the pair of SRS-Info is associated with one of the first group of SRS resources or ports and the other of the pair of SRS-Info is associated with the second group of SRS resources or ports. The first group of SRS resources or ports is associated with a first of the two groups of antenna ports. The second group of SRS resources or ports is associated with a second of the two groups of antenna ports. In various embodiments, the information about the at least one SRS-Info corresponds to one of: a SRS resource set including all of the one or more of G₁, G₂, G₃, and G₁₂, one SRS resource set for each of the one or more of G₁, G₂, G₃, and G₁₂, or two SRS resource sets, one of the two SRS resource sets for G₁ or G₂ and the other of the two SRS resource sets for G₃ or G₁₂.

The UE then receives an indication indicating X groups of the two groups of antenna ports (1210). For example, in 1210, X ∈ {1,2}. In various embodiments, the indication is via at least one indicator in a DCI and the at least one indicator includes: a joint indicator indicating one or both of the two groups or multiple indicators, each associated with a respective one of the two groups.

The UE then identifies the X groups of antenna ports (1215). For example, in 1215, the identification is based on the indication. In various embodiments, when a number of antenna ports is N, each of the two groups of antenna ports comprises N₁ antenna ports, where (N,N₁) = (8,4), (8,2), (8,1), (4,2), (4,1), or (2,1).

The UE then transmits an UL transmission based on the X groups of antenna ports (1220). For example, in 1220, the, when X = 1, the UL transmission corresponds to one PUSCH transmission from one of the two groups of antenna ports and, when X = 2, the UL transmission corresponds to one or two PUSCH transmissions from the two groups of antenna ports. In various embodiments, G₁ or G₂ is associated with X = 1 and the one PUSCH transmission and G₃ or G₁₂ is associated with X = 2 and the one or two PUSCH transmissions. In various embodiments, the UE may then transmit a report including information about one or more of G₁, G₂, G₃, and G₁₂.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive information about at least one sounding reference signal (SRS) related information (SRS-Info) that is associated with two groups of antenna ports, and
receive an indication indicating X groups of the two groups of antenna ports, where X ∈ {1,2}; and
a processor operably coupled to the transceiver, the processor, based on the indication, configured to identify the X groups of antenna ports, wherein:
the transceiver is further configured to transmit an uplink (UL) transmission based on the X groups of antenna ports,
when X = 1, the UL transmission corresponds to one physical uplink shared channel (PUSCH) transmission from one of the two groups of antenna ports, and
when X = 2, the UL transmission corresponds to one or two PUSCH transmissions from the two groups of antenna ports.

2. The UE of claim 1, wherein the at least one SRS-Info corresponds to a group of SRS resources or ports.

3. The UE of claim 1, wherein:
the at least one SRS-Info includes one or more of G₁, G₂, G₃, and G_{1,2}, where:
G₁ is a first SRS-Info that is associated with a first group of SRS resources or ports,
G₂ is a second SRS-Info that is associated with a second group of SRS resources or ports,
G₃ is a third SRS-Info that is associated with both the first and the second groups of SRS resources or ports, and
G_{1,2} is a pair of SRS-Info, one of the pair of SRS-Info is associated with one of the first group of SRS resources or ports and the other of the pair of SRS-Info is associated with the second group of SRS resources or ports,
the first group of SRS resources or ports is associated with a first of the two groups of antenna ports, and
the second group of SRS resources or ports is associated with a second of the two groups of antenna ports.

4. The UE of claim 3, wherein the information about the at least one SRS-Info corresponds to one of:
a SRS resource set including all of the one or more of G₁, G₂, G₃, and G₁₂,
one SRS resource set for each of the one or more of G₁, G₂, G₃, and G₁₂, or
two SRS resource sets, one of the two SRS resource sets for G₁ or G₂ and the other of the two SRS resource sets for G₃ or G₁₂ .

5. The UE of claim 3, wherein:
G₁ or G₂ is associated with X = 1 and the one PUSCH transmission, and
G₃ or G₁₂ is associated with X = 2 and the one or two PUSCH transmissions.

6. The UE of claim 1, wherein, when a number of antenna ports is N, each of the two groups of antenna ports comprises N₁ antenna ports, where (N, N₁) = (8,4), (8,2), (8,1), (4,2), (4,1), or (2,1).

7. The UE of claim 1, wherein:
the indication is via at least one indicator in a downlink control information (DCI), and
the at least one indicator includes:
a joint indicator indicating one or both of the two groups, or
multiple indicators, each associated with a respective one of the two groups.

8. The UE of claim 1, wherein the transceiver is further configured to transmit a report including information about one or more of G₁, G₂, G₃, and G₁₂ .

9. A base station (BS) comprising:
a transceiver configured to:
transmit information about at least one sounding reference signal (SRS) related information (SRS-Info) that is associated with two groups of antenna ports;
transmit an indication indicating X groups of the two groups of antenna ports, where X ∈ {1,2}; and
receive an uplink (UL) transmission based on the X groups of antenna ports,
wherein, when X = 1, the UL transmission corresponds to one physical uplink shared channel (PUSCH) transmission from one of the two groups of antenna ports, and
wherein, when X = 2, the UL transmission corresponds to one or two PUSCH transmissions from the two groups of antenna ports.

10. The BS of claim 9, wherein the at least one SRS-Info corresponds to a group of SRS resources or ports.

11. The BS of claim 9, wherein:
the at least one SRS-Info includes one or more of G₁, G₂, G₃, and G_{1,2}, where:
G₁ is a first SRS-Info that is associated with a first group of SRS resources or ports,
G₂ is a second SRS-Info that is associated with a second group of SRS resources or ports,
G₃ is a third SRS-Info that is associated with both the first and the second groups of SRS resources or ports, and
G_{1,2} is a pair of SRS-Info, one of the pair of SRS-Info is associated with one of the first group of SRS resources or ports and the other of the pair of SRS-Info is associated with the second group of SRS resources or ports,
the first group of SRS resources or ports is associated with a first of the two groups of antenna ports, and
the second group of SRS resources or ports is associated with a second of the two groups of antenna ports.

12. The BS of claim 11, wherein the information about the at least one SRS-Info corresponds to one of:
a SRS resource set including all of the one or more of G₁, G₂, G₃, and G₁₂,
one SRS resource set for each of the one or more of G₁, G₂, G₃, and G₁₂, or
two SRS resource sets, one of the two SRS resource sets for G₁ or G₂ and the other of the two SRS resource sets for G₃ or G₁₂.

13. The BS of claim 11, wherein:
G₁ or G₂ is associated with X = 1 and the one PUSCH transmission, and
G₃ or G₁₂ is associated with X = 2 and the one or two PUSCH transmissions.

14. The BS of claim 9, wherein, when a number of antenna ports is N, each of the two groups of antenna ports comprises N₁ antenna ports, where (N, N₁) = (8,4), (8,2), (8,1), (4,2), (4,1), or (2,1).

15. The BS of claim 9, wherein:
the indication is via at least one indicator in a downlink control information (DCI), and
the at least one indicator includes:
a joint indicator indicating one or both of the two groups, or
multiple indicators, each associated with a respective one of the two groups.

16. The BS of claim 9, wherein the transceiver is further configured to receive a report including information about one or more of G₁, G₂, G₃, and G₁₂.

17. A method performed by a user equipment (UE), the method comprising:
receiving information about at least one sounding reference signal (SRS) related information (SRS-Info) that is associated with two groups of antenna ports;
receiving an indication indicating X groups of the two groups of antenna ports, where X ∈ {1,2};
based on the indication, identifying the X groups of antenna ports; and
transmitting an uplink (UL) transmission based on the X groups of antenna ports,
when X = 1, the UL transmission corresponds to one physical uplink shared channel (PUSCH) transmission from one of the two groups of antenna ports, and
when X = 2, the UL transmission corresponds to one or two PUSCH transmissions from the two groups of antenna ports.

18. The method of claim 17, wherein the at least one SRS-Info corresponds to a group of SRS resources or ports.

19. The method of claim 17, wherein:
the at least one SRS-Info includes one or more of G₁, G₂, G₃, and G_{1,2}, where:
G₁ is a first SRS-Info that is associated with a first group of SRS resources or ports,
G₂ is a second SRS-Info that is associated with a second group of SRS resources or ports,
G₃ is a third SRS-Info that is associated with both the first and the second groups of SRS resources or ports, and
G_{1,2} is a pair of SRS-Info, one of the pair of SRS-Info is associated with one of the first group of SRS resources or ports and the other of the pair of SRS-Info is associated with the second group of SRS resources or ports,
the first group of SRS resources or ports is associated with a first of the two groups of antenna ports, and
the second group of SRS resources or ports is associated with a second of the two groups of antenna ports.

20. The method of claim 19, wherein the information about the at least one SRS-Info corresponds to one of:
a SRS resource set including all of the one or more of G₁, G₂, G₃, and G₁₂,
one SRS resource set for each of the one or more of G₁, G₂, G₃, and G₁₂, or
two SRS resource sets, one of the two SRS resource sets for G₁ or G₂ and the other of the two SRS resource sets for G₃ or G₁₂.
